(19) United States
(12) Patent Application Publication
(10) Pub. No.: US 2026/0017495 A1
(43) Pub. Date: Jan. 15, 2026

(54) Generative AI Output Caching with Input Guidance

(71) Applicant: DeepMind Technologies Limited, London (GB)

(72) Inventors: Obaid Sarvana, Plainfield, IL (US); Swaroop Ranjan Mishra, Santa Clara, CA (US)

(21) Appl. No.: 18/766,994

(22) Filed: Jul. 9, 2024

(51) Int. Cl. G06N 3/0475; G06N 3/045

(52) U.S. Cl. CPC G06N 3/0475; G06N 3/045

(57) ABSTRACT

Example systems and methods are provided. A method can include receiving, by a computing system comprising one or more computing devices, a first input for a generative machine-learned model. The method can include identifying, by the computing system, from a first data structure comprising data indicative of a plurality of respective second inputs, one or more second inputs based on the first input. The method can include retrieving, by the computing system from a second data structure correlating the plurality of respective second inputs to a plurality of corresponding outputs generated by the generative machine-learned model based at least in part on the respective second inputs, an output corresponding to at least one second input of the one or more second inputs. The method can include outputting, by the computing system, the output corresponding to the at least one second input.

### FIELD

The present disclosure relates generally to machine learning processes and machine-learned devices and systems. More particularly, the present disclosure relates to systems and methods for caching outputs generated by machine-learned systems, and for retrieving cached outputs based on inputs directed to machine-learned systems.

### BACKGROUND

A computer can receive input(s). The computer can execute instructions to process the input(s) to generate output(s) using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method. The method includes receiving, by a computing system comprising one or more computing devices, a first input for a generative machine-learned model. The method includes identifying, by the computing system from a first data structure comprising data indicative of a plurality of respective second inputs, one or more second inputs based on the first input. The method includes retrieving, by the computing system from a second data structure correlating the plurality of respective second inputs to a plurality of corresponding outputs generated by the generative machine-learned model based at least in part on the respective second inputs, an output corresponding to at least one second input of the one or more second inputs. The method includes outputting, by the computing system, the output corresponding to the at least one second input.

Example implementations can include some or all of the following features. In some implementations, the method further includes: providing, by the computing system to a user prior to retrieving the output corresponding to the at least one second input, the one or more second inputs; and receiving, by the computing system from the user prior to retrieving the output corresponding to the at least one second input, an interface interaction indicative of the at least one second input. In some implementations, the output corresponding to the at least one second input is retrieved based on the interface interaction. In some implementations, the first data structure comprises a tree data structure, and the method further includes: receiving, by the computing system from the user, one or more first tokens of the first input; identifying, by the computing system from the first data structure, one or more first input suggestions based at least in part on the one or more first tokens; receiving, by the computing system from the user subsequent to receiving the first token, one or more second tokens of the first input; and identifying, by the computing system from the first data structure, the one or more second inputs based at least in part on the one or more first tokens and the one or more second tokens. In some implementations, the one or more second inputs are identified based on a metric of similarity between the first input and the one or more second inputs. In some implementations, the metric of similarity comprises a metric of distance between a machine-learned embedding of the first input and one or more machine-learned embeddings of the one or more second inputs. In some implementations, the metric of similarity comprises a keyword frequency metric. In some implementations, the metric of similarity comprises an edit distance metric. In some implementations, the method further includes receiving, by the computing system from a user, an interface interaction associated with the one or more second inputs. In some implementations, the method further includes updating, by the computing system based on the interface interaction, at least one of: the metric of similarity; and a similarity threshold, wherein the one or more second inputs are identified based at least in part on the similarity threshold. In some implementations, the method further includes receiving, by the computing system, a third input; providing, by the computing system, the third input to the generative machine-learned model; generating, by the generative machine-learned model based on the third input, a third output; storing, by the computing system in the first data structure, data indicative of the third input; and storing, by the computing system in the second data structure, a data item correlating the third input to the third output. In some implementations, the method further includes receiving, by the computing system from a user, an interface interaction indicative of user satisfaction with the third output; wherein storing the data indicative of the third input in the first data structure is based at least in part on the interface interaction; and wherein storing the data item is based at least in part on the interface interaction. In some implementations, the method further includes receiving, by the computing system from a user, an interface interaction indicative of user dissatisfaction with the output corresponding to the at least one second input; removing, by the computing system from the first data structure or second data structure, at least one of: a data item used to identify the at least one second input based on the first input; and a data item correlating the at least one second input to the output corresponding to the at least one second input. In some implementations, the method further includes retrieving, by the computing system from the second data structure, data indicative of a freshness of the output corresponding to the at least one second input; wherein the outputting is based at least in part on the data indicative of the freshness. In some implementations, the method further includes receiving, by the computing system, a third input for the generative machine-learned model; identifying, by the computing system from the first data structure, one or more fourth inputs based on the third input; retrieving, by the computing system from a third data structure correlating a plurality of respective fourth inputs to a plurality of corresponding output templates, a fourth output template corresponding to at least one fourth input of the one or more fourth inputs; generating, by the computing system based on the fourth output template, a fourth output; and outputting, by the computing system, the fourth output. In some implementations, generating the fourth output comprises: providing, by the computing system to the generative machine-learned model, data indicative of at least a portion of the fourth output template; and generating, by the generative machine-learned model based on the data indicative of at least a portion of the fourth output template, at least a portion of the fourth output. In some implementations, generating the fourth output comprises: accessing, by the computing system based at least in part on the fourth output template, an application programming interface; and receiving, from the application programming interface, at least a portion of the fourth output. In some implementations, the first input is associated with a natural language, and identifying the one or more second inputs comprises: mapping, by the computing system, the first input to a domain-specific input language having at least one of: a syntax that is different from a syntax of the natural language; a vocabulary that is different from a vocabulary of the natural language; and an alphabet that is different from an alphabet of the natural language; and identifying, by the computing system based at least in part on the mapping, the one or more second inputs. In some implementations, the method further includes providing, by the computing system, a signal to cause a client device to implement an on-device data structure correlating a plurality of fifth inputs to a plurality of corresponding fifth outputs generated by the generative machine-learned model based at least in part on the fifth inputs. In some implementations, the method further includes receiving, by the computing system from a user associated with the client device, one or more sixth inputs; and adding, by the computing system based at least in part on the sixth inputs, one or more data items to the on-device data structure; wherein at least one data item of the one or more data items comprises data indicative of a seventh input that has not been received by the computing system from the user.

Another example aspect is directed to a computing system comprising one or more processors and one or more non-transitory computer-readable media storing instructions that are executable by the one or more processors to cause the computing system to perform operations. The operations include receiving a first input for a generative machine-learned model. The operations include identifying, from a first data structure comprising data indicative of a plurality of respective second inputs, one or more second inputs based on the first input. The operations include retrieving, from a second data structure correlating the plurality of respective second inputs to a plurality of corresponding outputs generated by the generative machine-learned model based at least in part on the respective second inputs, an output corresponding to at least one second input of the one or more second inputs. The operations include outputting the output corresponding to the at least one second input.

Another example aspect is directed to one or more non-transitory computer-readable media storing instructions that are executable by a computing system to perform operations. The operations include receiving a first input for a generative machine-learned model. The operations include identifying, from a first data structure comprising data indicative of a plurality of respective second inputs, one or more second inputs based on the first input. The operations include retrieving, from a second data structure correlating the plurality of respective second inputs to a plurality of corresponding outputs generated by the generative machine-learned model based at least in part on the respective second inputs, an output corresponding to at least one second input of the one or more second inputs. The operations include outputting the output corresponding to the at least one second input.

Other aspects of the present disclosure are directed to various systems, apparatuses, non-transitory computer-readable media, user interfaces, and electronic devices. For example, a computing system can be configured to perform any method as described in any implementation herein. For example, computer-readable media can store computer-executable instructions for performing any method as described in any implementation herein.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

FIG. 1 is a block diagram of an example system for retrieving cached machine-learned outputs according to example implementations of aspects of the present disclosure;

FIG. 2 is a block diagram of an example system for providing input guidance according to example implementations of aspects of the present disclosure;

FIG. 3 is a block diagram of an example system for providing input guidance according to example implementations of aspects of the present disclosure;

FIG. 4 is a block diagram of an example system for generating and storing machine-learned outputs according to example implementations of aspects of the present disclosure;

FIG. 5 is a block diagram of an example system for updating a cache datastore based on user interactions according to example implementations of aspects of the present disclosure;

FIG. 6 is a block diagram of an example system for generating an output based on a cached template according to example implementations of aspects of the present disclosure;

FIG. 7 is a block diagram of an example system for storing cached data on a client computing system and a server computing system according to example implementations of aspects of the present disclosure;

FIG. 8 is a flowchart diagram of an example method for retrieving cached machine-learned outputs according to example implementations of aspects of the present disclosure;

FIG. 9 is a flowchart diagram of an example method for generating and storing machine-learned outputs according to example implementations of aspects of the present disclosure;

FIG. 10 is a flowchart diagram of an example method for generating an output based on a cached template according to example implementations of aspects of the present disclosure;

FIG. 11 is a flow chart diagram illustrating an example method for training a machine-learned model according to example implementations of aspects of the present disclosure;

FIG. 12 is a block diagram of an example processing flow for using machine-learned model(s) to process input(s) to generate output(s) according to example implementations of aspects of the present disclosure;

FIG. 13 is a block diagram of an example sequence processing model according to example implementations of aspects of the present disclosure;

FIG. 14 is a block diagram of an example technique for populating an example input sequence for processing by a sequence processing model according to example implementations of aspects of the present disclosure;

FIG. 15 is a block diagram of an example model development platform according to example implementations of aspects of the present disclosure;

FIG. 16 is a block diagram of an example training workflow for training a machine-learned model according to example implementations of aspects of the present disclosure;

FIG. 17 is a block diagram of an inference system for operating one or more machine-learned model(s) to perform inference according to example implementations of aspects of the present disclosure;

FIG. 18 is a block diagram of an example networked computing system according to example implementations of aspects of the present disclosure;

FIG. 19 is a block diagram of an example computing device according to example implementations of aspects of the present disclosure; and

FIG. 20 is a block diagram of an example computing device according to example implementations of aspects of the present disclosure.

### DETAILED DESCRIPTION

Generally, the present disclosure is directed to systems and methods for caching outputs generated by machine-learned sequence processing models (e.g., generative language models, image generation models, multimodal models, etc.), and for retrieving cached outputs based on inputs (e.g., user inputs) directed to the machine-learned models. A cache can be a data storage component that stores data (e.g., previously retrieved data, previously computed data, etc.) to enable efficient retrieval of that data in the future. For example, a computing system can receive an input from a user; generate, based on the input using a machine-learned sequence processing model (e.g., generative language model, etc.), an output; provide the output to the user; and add the input and output to a cache for storing previously generated machine-learned outputs. Later, the computing system can receive a second input (e.g., from a second user) that is similar or identical to the previous input. Based on the second input, the computing system can retrieve the previous input and corresponding output from the cache, and can provide the corresponding output to the second user. In this manner, for instance, a computing system can avoid wasting computational resources to recompute another output based on a similar or identical input.

In some instances, the computing system can “guide” a received input toward a cached input for which a cached output already exists. Input guidance can include, for example, autocompletion; autocorrection; input matching; input suggestions; or other input guidance. For example, a computing system can provide, based on a received input (e.g., complete input, partial input, etc.), an “autocompletion” suggestion comprising a cached input for which a cached output already exists. If the user accepts the autocompletion suggestion, the computing system can provide a cached output corresponding to the cached input suggested by the autocompletion suggestion. As another example, a computing system can receive an input that is similar to, but slightly different from, a cached input (e.g., due to a typographical error; altered punctuation; grammatical error; minor rewording or paraphrasing; etc.). In some instances, the similar input may have the same meaning as the cached input, despite slight differences between the inputs. In such instances, the computing system can retrieve, based on a measure of similarity between the received input and one or more cached inputs, a cached output to provide to the user. In some instances, a measure of similarity can include a measure of semantic similarity (e.g., a measure of distance between machine-learned semantic embeddings), keyword-based similarity (e.g., keyword frequency-based metric), character-wise similarity (e.g., Levenshtein edit distance), or other similarity metric. In some instances, the similar input can be provided to a user for approval before returning a cached output corresponding to the similar input. In other instances, the similar input may be used directly without pre-approval from a user (e.g., with or without an explanatory sentence describing the difference between the user input and the cached input).

In some instances, guiding a received input toward a cached input can include incorporating additional context into the input. For example, in some instances, a received input can include a single turn of a multi-turn conversation (e.g., conversation with a machine-learned chatbot application, etc.), and guiding the received input toward a cached input can include incorporating context from the multi-turn conversation into the single-turn input. As a non-limiting illustrative example, if a prior turn of a multi-turn conversation includes a user saying, “I am planning a trip to Cleveland this weekend,” and a later user input from the same multi-turn conversation includes the question, “What will the weather be like?”, a computing system can incorporate the context into the input to generate a contextualized input (e.g., “What will the weather be like in Cleveland this weekend?,” etc.). In this manner, for instance, a received input can be correlated with a cached input comprising sufficient context to retrieve a cached output that is helpful or otherwise desirable to a user. In some instances, incorporating context into a received input can include generating one or more machine-learned embeddings based on the received input and additional context associated with the received input; and generating, by a machine-learned generation model based on the machine-learned embeddings, a contextualized input.

In some instances, the cache or the input guidance system can be periodically updated based on user feedback. User feedback can include, for example, direct user feedback (e.g., thumbs up or down button, etc.) or indirect user feedback (e.g., follow-up inputs, such as inputs of a multi-turn conversation; user interactions such as clicking on a link provided in a generated or retrieved output; etc.). For example, upon receiving user feedback indicative of user dissatisfaction, a computing system can remove a cached output from the cache; disassociate a cached input from a corresponding cached output or a corresponding initial (i.e., unguided) user input; or otherwise update a system responsive to the user feedback. As another example, upon receiving user feedback indicative of user satisfaction, a computing system can add a newly generated output to the cache; store data correlating a cached or guided input to an unguided user input; or otherwise update a system responsive to the user feedback. In some instances, the cache can be updated using other human intervention methods, such as storing cached human-generated or human-edited outputs; supplementing user feedback with other human feedback (e.g., content moderation, output evaluation, etc.); or other interventions.

In some instances, a cache can include one or more output templates for generating outputs at reduced computational cost compared to generating outputs from scratch. As a non-limiting illustrative example, an input saying “Tell me about today's weather” may be associated with a cached output template for retrieving and outputting weather data. In some instances, an output template can include a template for calling an application programming interface (API) to generate an output. For example, continuing the non-limiting illustrative example, a weather application may have a weather API for retrieving the most recent weather data, and an output template can include an instruction for calling the weather API to retrieve today's high temperature; low temperature; current temperature; precipitation likelihood; or other weather data. The output template can further include, for example, a “fill-in-the-blank” template component, such as “Today's high temperature is <API-high-temp> and today's low temperature is <API-low-temp>, with a <API-precip-chance> of precipitation. The current temperature is <API-current-temp>.” In some instances, an output template can include a template (e.g., fill-in-the-blank template, etc.) for generating the output using a machine-learned model (e.g., generative language model, etc.).

In some instances, a cached output can be checked for freshness before providing the cached output to a user (e.g., immediately before; periodically; immediately after the output is generated; etc.). As an illustrative example, an output generated based on an input asking, “How is the weather in Cleveland today?” may remain “fresh” for one day or less after the output is generated. In some instances, a lightweight (e.g., small, low-computational-cost, etc.) machine-learned model (e.g., classifier model, etc.) can be trained to check a cached output for freshness based on one or more of: the cached output; a corresponding cached input; a date or time the cached output was generated; or other relevant data. In some instances, an “expiration date” for a cached output can be determined at the time of generation, or a freshness can be determined after retrieving the cached output from the cache (e.g., without reference to an expiration date).

In some instances, cached outputs can be periodically pre-generated based on usage patterns associated with a machine-learned sequence processing model. As a non-limiting illustrative example, if a computing system regularly receives inputs asking about today's weather, the computing system can pre-generate each day, based on that usage pattern, a daily weather summary to store in the cache in place of yesterday's weather summary, which is no longer fresh. In this manner, for instance, a latency (i.e., waiting time from when an input entered to when the user sees a response based on the input) associated with a predictable or common input can be reduced, and a user experience can be improved.

In some instances, a cache can include both an on-device cache (e.g., on a user device such as a smartphone) and a server-side cache on a different device from the on-device cache. In some instances, an on-device cache on a user device (e.g., phone, tablet, etc.) can be populated based on usage patterns of a user associated with the device. As a non-limiting illustrative example, if the user has asked questions in the past about Philadelphia sports teams, an on-device cache can be populated with cached outputs associated with Philadelphia sports results. By storing some cached outputs on-device, a latency associated with cache-based output retrieval can be reduced. Additionally, by storing only the most relevant cached outputs on-device, a total size (e.g., in megabytes of storage space) of the on-device cache can be reduced, such that an on-device cache can comfortably fit within a user device's (e.g., smartphone's) limited storage space.

Systems and methods according to the present disclosure can provide a variety of technical effects and benefits, such as reduced computational cost (e.g., memory usage, processor usage, electricity usage, time cost such as latency, etc.) of providing machine-generated outputs; reduced memory footprint of an output cache; improved quality (e.g., improved accuracy, user satisfaction, reduced latency, etc.) of machine-generated outputs; and reduced cost (e.g., computational cost, data collection costs, labor cost, etc.) of quality control.

Some example implementations of the present disclosure can provide machine-generated outputs at reduced computational cost compared to some alternative systems and methods. For example, some alternative methods may require a fresh inference cycle using a machine-learned model (e.g., large language model, image generation model, etc.) every time an input is received (e.g., even when an input is identical to a previously received input). Each inference cycle may require a significant amount of computational resources (e.g., processor resources such as central processing unit (CPU) operations, graphics processing unit (GPU) operations, tensor processing unit (TPU) or other application-specific integrated circuit (ASIC) operations; memory resources such as high-bandwidth memory, etc.). In contrast, systems and methods according to some aspects of the present disclosure can retrieve cached outputs, not only when a received input is identical to a prior input, but also when a received input can be guided toward a prior input (e.g., based on autocompletion, autocorrection, similarity, context incorporation, etc.), thereby reducing a computational cost of providing machine-generated outputs compared to alternative methods. In this manner, for instance, example implementations of the present disclosure can improve the functioning of a computing system.

Some example implementations of the present disclosure can provide reduced memory footprint of an output cache compared to alternative methods. For example, some alternative cache retrieval methods may include retrieving cached outputs only when a received input is identical to a cached input. However, some machine-learned sequence processing models (e.g., large language models, etc.) may be configured to receive unstructured input in a format that allows a large number of slightly different inputs with the same meaning. As a non-limiting illustrative example, the inputs “tell me about todays weather,” “Tell me about today's weather,” “Tell me about today's weather.”, “Please tell me about today's weather,” “plz tell me about todays weather,” “what will the weather be like today”, and “waht will the weather be like today” are just a small percentage of a large number of possible non-identical inputs having the same meaning as “What's today's forecast?” As another example, an input of “What will the weather be like?,” in the context of a multi-turn conversation starting with “I am planning a trip to Cleveland this weekend,” may have the same meaning as a context-free input of “What will the weather be like in Cleveland this weekend?” In some instances, the number of possible non-identical input options having the same meaning may be so large (e.g., millions, billions, or more), that caching input-output pairs based on identical inputs may be impractical due to low cache hit rates, prohibitively high memory requirements, increased cost of memory retrieval due to increased cache size, and other technical problems associated with increased cache size. In contrast, systems and methods according to some aspects of the present disclosure can provide cache storage and retrieval in a manner that accounts for non-identical inputs, thereby reducing a cache size compared to some alternative implementations. This reduced cache size can provide a variety of technical effects and benefits, such as reduced memory footprint; reduced cost of retrieval due to smaller memory search space; increased cache hit rates leading to reduced computational costs associated with fresh generation of machine-learned outputs; and other technical benefits.

Some example implementations can provide improved output quality (e.g., accuracy, user satisfaction, etc.) compared to alternative methods. For example, in some alternative implementations, a machine-learned model may generate a fresh output each time an input is received (including, e.g., identical or duplicate inputs). In some instances, the output may be non-deterministic (e.g., having a random component), meaning that identical inputs may lead to different outputs each time. In such instances, a machine learning provider may have few tools to control an output quality of the generated outputs, other than re-training a machine learning model. In contrast, systems and methods according to some aspects of the present disclosure can determine, based on user feedback, whether to store or retain a generated output in the cache. In this manner, for instance, example implementations of the present disclosure can ensure that outputs provided from the cache are high quality (e.g., accurate, etc.).

Additionally, systems and methods that can enable higher-quality outputs at a given computational cost can also be adapted to enable similar-quality outputs at a reduced computational cost compared to some alternative methods. For example, in some instances, output quality of a machine-learned model can be increased by increasing a computational complexity of the machine-learned model (e.g., size, number of parameters, etc.). However, increasing a computational complexity of the machine-learned model can increase a computational cost (e.g., electricity cost, processor usage, memory usage, etc.) of training and inference using the machine-learned model. Conversely, reducing a computational complexity of a machine-learned model can decrease a cost of operating that machine-learned model, at the cost of a reduction in accuracy. Thus, systems and methods that can enable higher-quality outputs using a given model size or computational cost can be adapted (e.g., by reducing a size of the machine-learned model) to provide similar quality outputs at a reduced computational cost compared to alternative methods. In this manner, for instance, example implementations of the present disclosure can improve the functioning of the computing system and machine learning technology.

Additionally, some example implementations of the present disclosure can reduce various costs (e.g., computational costs, data requirements, etc.) associated with quality control of machine-generated outputs. As an example, some alternative implementations may generate a fresh machine-learned output each time an input is received (e.g., including identical or duplicate inputs). In some instances, the generation process may be non-deterministic, meaning that even identical inputs may lead to different machine-learned outputs, thereby leading to a large number (e.g., thousands, millions, or more) of distinct outputs based on inputs having the same or similar meanings. In some instances, an amount of data required to estimate output quality of those outputs may depend on the number of distinct outputs being evaluated. Therefore, a large amount of data may be required to estimate the quality of the large number of distinct outputs generated by some alternative implementations. In contrast, some example implementations of the present disclosure can re-use cached outputs to reduce a number of distinct outputs generated, thereby reducing an amount of data required to track output quality and adjust the outputs based on the quality data. Additionally, a reduced amount of data can lead to other reductions in computational cost, such as reduced computational cost (e.g., processor usage, memory usage, electricity cost, etc.) of communicating, storing, retrieving, and processing quality data. In this manner, for instance, example implementations of the present disclosure can improve the functioning of computing technology and machine learning technology.

Various example implementations are described herein with respect to the accompanying Figures.

### Example Systems

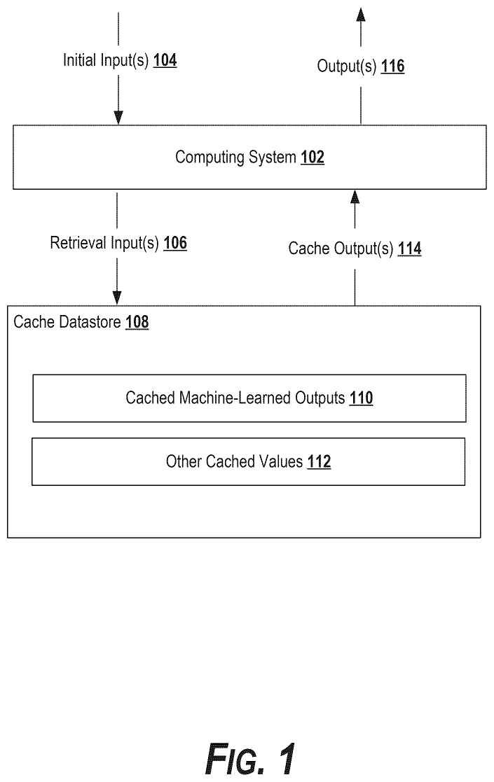

FIG. 1 is a block diagram of an example system for retrieving cached machine-learned outputs based on a received input. A computing system 102 can receive one or more initial inputs 104. Based on the initial input(s) 104, the computing system 102 can determine one or more retrieval inputs 106. Based on the retrieval input(s) 106, the computing system can retrieve one or more cache output(s) 114 from a cache datastore 108 comprising cached machine-learned outputs 110 and other cached values 112. Based on the cache output(s) 114, the computing system 102 can output one or more output(s) 116.

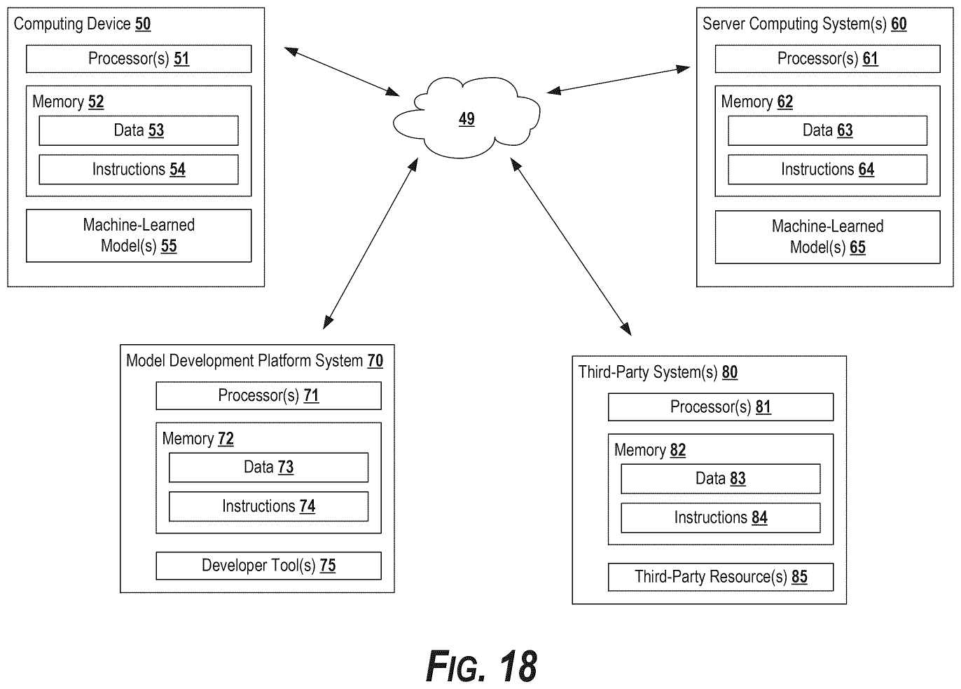

A computing system 102 can be or include one or more software, firmware, or hardware components configured to process initial inputs 104 to generate retrieval inputs 106 or otherwise retrieve data from a cache datastore 108 based on the initial inputs 104. In some instances, the computing system 102 can be, comprise, be comprised by, or share one or more properties with a computing device or system described below with respect to FIGS. 18-20 (e.g., server computing system 60, model development platform system 70, computing device 98, computing device 99, etc.).

Initial input(s) 104 can generally include or otherwise represent various types of data. Initial input(s) 104 can include one type or many different types of data.

Retrieval input(s) 106 can generally include or otherwise represent various types of data. Retrieval input(s) 106 can include one type or many different types of data. Retrieval input(s) 106 can be data of the same type(s) or of different types of data as compared to initial input(s) 104. In some instances, a retrieval input 106 can be the same as or different from a corresponding initial input 104 used to generate a retrieval input 106.

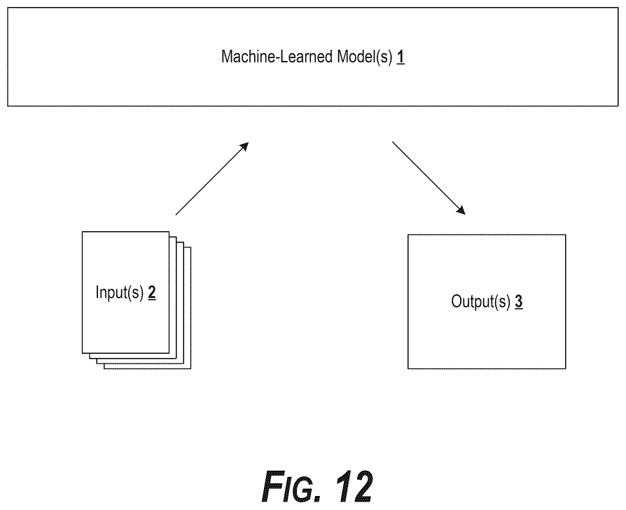

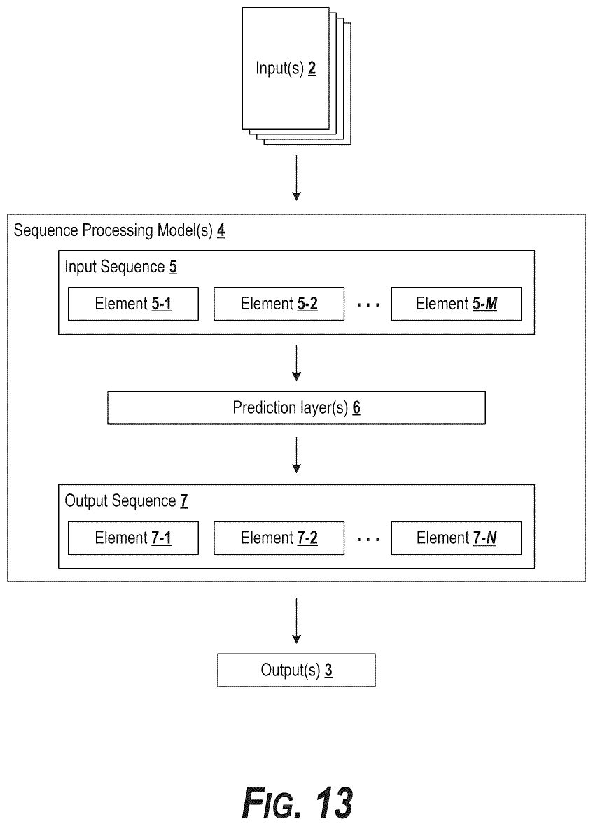

Example data types for initial input(s) 104 or retrieval input(s) 106 include natural language data (e.g., text, audio, etc.), image data, video data, or other data type (e.g., as described below with respect to FIGS. 12-13, etc.). In some instances, an initial input 104 or retrieval input 106 can include sequence data (e.g., natural language sequence, text sequence, audio sequence, video sequence, image sequence, etc.). Data can be raw or processed and can be in any format or schema. In some instances, an initial input 104 or retrieval input 106 can include machine-learned embedding data. For example, in some instances, an initial input 104 can include natural language data (e.g., raw or unprocessed natural language data such as text or audio data), and a corresponding retrieval input 106 can include machine-learned embedding data generated based on the initial input 104 (e.g., using a machine-learned natural language model such as a sentence embedding model, etc.).

In multimodal initial input(s) 104 or retrieval input(s) 106, example combinations of data types include image data and audio data, image data and natural language data, audio data and text data, natural language data and software code data, image data and biometric data, sensor data and medical data, etc. It is to be understood that any combination of data types in an initial input 104 or a retrieval input 106 can be present.

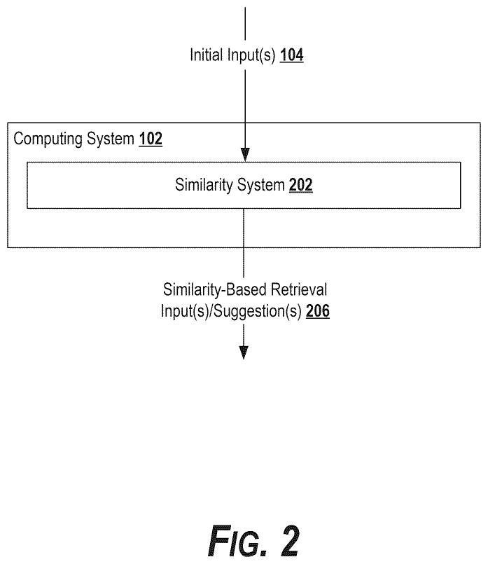

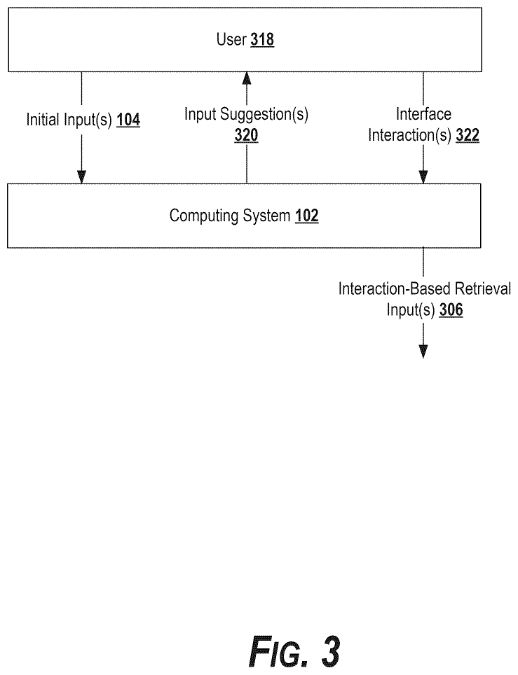

In some instances, one or both of the initial input 104 and retrieval input 106 can be multimodal. For example, in some instances, an initial input 104 can be multi-modal, and a corresponding retrieval input 106 can be multi-modal or unimodal in various implementations. As a non-limiting illustrative example, a multi-modal initial input 104 may include a combination of an audiovisual item (e.g., image, video clip, audio clip, etc.) and a text input or natural language input (e.g., a question about the audiovisual item, etc.). In such instances, a retrieval input 106 can in some instances include a multi-modal retrieval input 106 (e.g., having the same combination of input types as the initial input 104). In some instances, determining a retrieval input 106 can include determining an audiovisual portion of the retrieval input 106 based on the audiovisual portion of the initial input 104; determining a text portion of the retrieval input 106 based on the text portion of the initial input 104; determining a combined retrieval input 106 based on the combined initial input 104 (e.g., based on a combined machine-learned embedding of both portions of the initial input 104); or the like. As a non-limiting illustrative example, a user may input an image with a question about the image; a plurality of retrieval inputs 106 comprising similar images or exact-match images may be retrieved; and a user can be guided toward a cached retrieval input 106 comprising a similar or exact-match image and a corresponding question for which an answer has already been generated and stored in the cache datastore 108. Further details of example implementations for providing input guidance are further described below with respect to FIGS. 2 and 3.

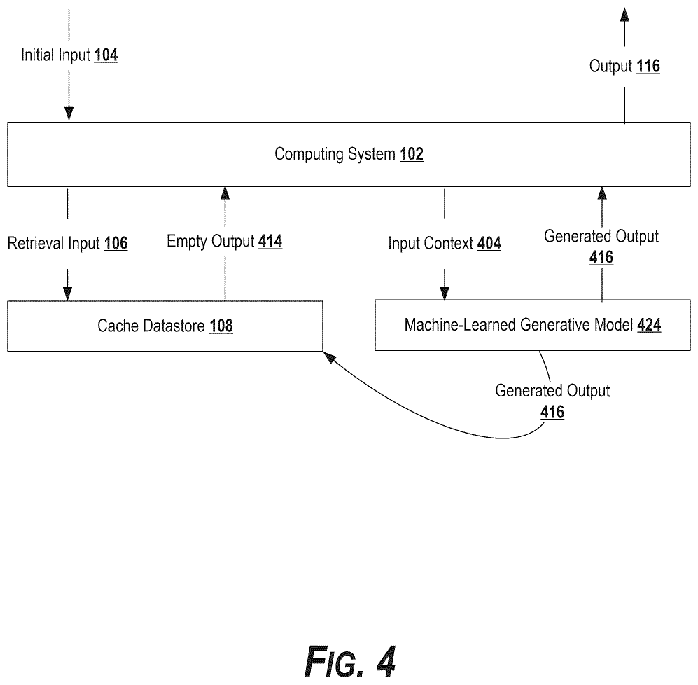

In some instances, an initial input 104 can be a multimodal input, and one or more corresponding retrieval inputs 106 can be unimodal inputs or can share a subset of the input types of the initial input 104. As a non-limiting illustrative example, a user can input an image with a corresponding question; a first retrieval input 106 can be determined based on the image; and a first cache output 114 (e.g., cached description of the image generated by a vision language model, etc.) can be determined based on the first retrieval input 106. An output 116 can then be determined based at least in part on the first cache output 114. For example, in some instances, a second retrieval input 106 can be determined based on the first cache output 114 and the user's question, and a second cache output 114 can be retrieved based on the second retrieval input 106. As another example, the first cache output 114 can be provided to a generative machine-learned model in combination with the user's question, and the machine-learned model can generate an output. Further details of an example implementation comprising machine-learned output generation are provided below with respect to FIG. 4.

In some instances, a computing system 102 can determine a retrieval input 106 based at least in part on an initial input 104. In some instances, determining a retrieval input 106 can include retrieving (e.g., from a datastore such as a cache datastore 108) a retrieval input 106 based on the initial input 104; receiving a retrieval input 106 (e.g., from another computing device responsive to providing the initial input 104 to the other computing device); generating the retrieval input 106 based on the initial input 104; or a combination thereof. In some instances, a retrieval input 106 can be, comprise, be comprised by, correspond to, or otherwise be associated with an input portion of an input-output pair stored in the cache datastore 108. In some instances, determining a retrieval input 106 can include determining, based at least in part on an initial input 104, a retrieval input 106 configured to correspond to a portion of a data item (e.g., input-output pair, etc.) stored in the cache datastore 108. Additional example implementation details for some example systems for determining retrieval inputs 106 are further provided below with respect to FIGS. 2 and 3.

Cache datastore 108 can include any data structure for storing data (e.g., database, table, row, column, file system, file, folder, object of an object-oriented programming language, object of a graph-structured object database, memory region or sequence of memory addresses, etc.) and can be implemented by one or more devices for storing data permanently or temporarily (e.g., non-volatile memory such as solid state drive, hard disk drive, etc.; volatile or semi-volatile memory such as random access memory, etc.). In some instances, a cache datastore 108 can include a data structure correlating (e.g., pairing, etc.) a plurality of inputs 104, 106 with a plurality of corresponding cached machine-learned outputs 110 generated based on the inputs 104, 106. In some instances, a cache datastore 108 can include a data structure correlating a plurality of inputs 104, 106 with a plurality of corresponding other cached values 112 associated with the inputs 104, 106. In some instances, a cache datastore 108 can include a plurality of data items, wherein each data item of the plurality of data items correlates (e.g., pairs, associates, etc.) an input 104, 106 with a corresponding cached value 110, 112. In some instances, a cache datastore 108 can be stored in a manner that enables efficient cache retrieval (e.g., low latency, low communication overhead, low electricity cost, etc.) compared to some alternative methods. For example, in some instances, a cache datastore 108 can be stored in fast volatile memory to reduce retrieval latency compared to storing on non-volatile storage. In some instances, a cache datastore 108 can be stored on a device that receives an initial input 104 (e.g., from a user) or implements a machine-learned model (e.g., as described below with respect to FIG. 4), thereby reducing a communication overhead by eliminating or reducing calls to external servers or services. In some instances, a cache datastore 108 can be internal to an application that receives an initial input 104 or implements a machine-learned model, thereby reducing computational overhead associated with inter-application communication compared to some alternative methods.

Cached machine-learned outputs 110 can include outputs that have been generated in the past by a machine-learned model (e.g., generative machine-learned sequence processing model, etc.) based on one or more inputs (e.g., initial inputs 104, retrieval inputs 106, etc.). In some instances, cached machine-learned outputs 110 can include sequence outputs such as natural language sequence data (e.g., text, audio, etc.), image data, audio data, and the like; multimodal outputs such as combined text and audio data; combined image and audio data; combined text and image data; multimodal video data; and the like. Further details of example data types for a cached machine-learned output 110 are provided below with respect to FIGS. 12-14. Data can be raw or processed and can be in any format or schema. In some instances, a cached machine-learned output 110 can be stored in combination with a corresponding input used to generate the cached machine-learned output 110 (e.g., as part of an input-output pair or other data item comprising a cached machine-learned output 110 and corresponding input).

Cached machine-learned outputs 110 can generally include or otherwise represent various types of data. Cached machine-learned outputs 110 can include one type or many different types of data. Cached machine-learned outputs 110 can be data of the same type(s) or of different types of data as compared to initial input(s) 104 and retrieval inputs 106. As a non-limiting illustrative example, in some instances, an initial input 104 can include natural language data (e.g., text, audio, etc.) comprising an instruction to generate a particular type of output (e.g., image; video; music, speech, or other audio; etc.), and a corresponding cached machine-learned output 110 can include an output of that particular type.

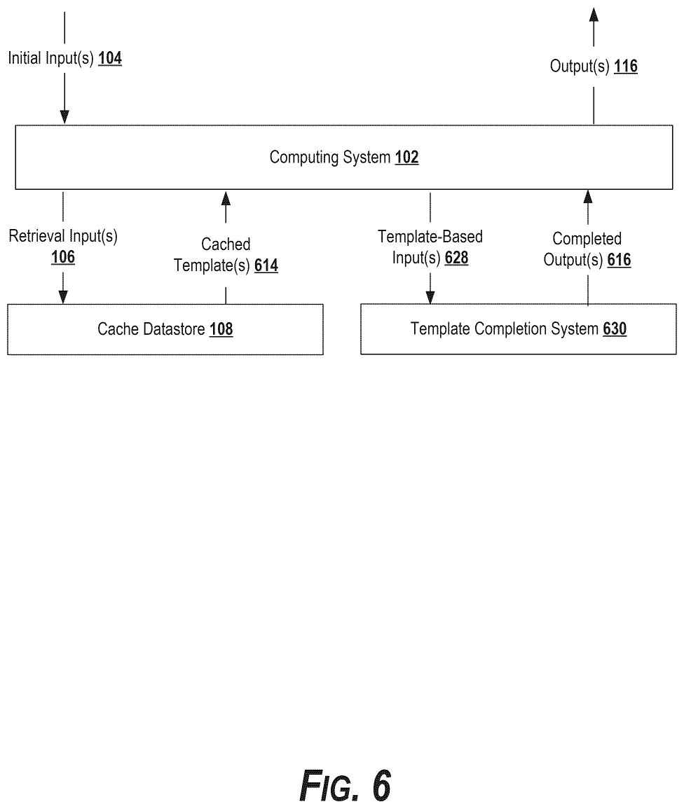

Other cached values 112 can include any stored data that is not a cached machine-learned output 110. In some instances, other cached values 112 can include output values generated without using a machine-learned model (e.g., human-generated outputs, etc.), or using other tools in combination with a machine-learned model (e.g., human-edited outputs, API-generated outputs, etc.). In some instances, other cached values 112 can include non-output values. For example, in some instances, other cached values 112 can include input values or intermediate values for generating an output 116. For example, in some instances, other cached values 112 can include instruction content (e.g., computer code, input context for a machine-learned sequence processing model comprising instruction content, etc.) for generating an output 116. In some instances other cached values 112 can include partial output values (e.g., templates, sentences, paragraphs, etc.) to be included in an output 116 or otherwise used to generate an output 116. In some instances, other cached values 112 can include templates for generating an output 116. Templates can include, for example, any or all of: instruction content for generating all or part of an output; stored content comprising one or more partial outputs (e.g., precomputed or cached partial outputs); instruction content for combining two or more partial outputs; and the like. Example details of an example system for using templates to generate an output 116 according to some aspects of the present disclosure are further provided below with respect to FIG. 6.

Cache outputs 114 can include, for example, any data that is retrieved from or otherwise output by a cache datastore 108 or data retrieval system interacting with the cache datastore 108. For example, cache outputs 114 can include cached machine-learned outputs 110 or other cached values 112; corresponding input values associated with the cached machine-learned outputs 110 or other cached values 112 (e.g., input used to generate a corresponding cached machine-learned output 110, etc.); and any other related data. In some instances, a cache output 114 can be retrieved based on a retrieval input 106 according to an exact match between a retrieval input 106 and other data (e.g., input data associated with a cached value 110, 112, etc.), or according to an inexact match (e.g., based on a metric of similarity, etc.). In some instances, an inexact match can include matching based on a metric of similarity, such as a metric of similarity described below with respect to FIG. 2.

In some instances, a cache output 114 can include data indicative of a freshness of a cached machine-learned output 110 or other cached value 112 associated with the cache output 114. For example, in some instances, a cache output 114 may include data indicative of an “expiration date,” or a day or time that a cached value 110, 112 of the cache output 114 is no longer fresh. In some instances, a computing system 102 can compare a current date or time (e.g., at a time the cache output 114 is retrieved, etc.) to a stored day or time after which the cached value 110, 112 is no longer fresh. If a retrieved value is determined not to be fresh, then the computing system 102 can in some instances retrieve a different cached value 110, 112 (e.g., based on a different retrieval input 106); generate a new output using a machine-learned model (e.g., according to example implementations described below with respect to FIG. 4); or take other appropriate action.

In some instances, data indicative of freshness can include other data, such as a date the output was generated; a cached value 110, 112; an input 104, 106 associated with the cached value 110, 112; or other data indicative of a freshness of the cached value 110, 112. In some instances, a computing system 102 can determine whether an output is fresh using a lightweight machine-learned model (e.g., having a smaller number of parameters than a generative machine-learned model for generating cached machine-learned outputs 110, etc.), such as a machine-learned classifier model (e.g., neural network model such as multilayer perceptron, etc.). In some instances, an input to a machine-learned freshness classifier model can include date and time data (e.g., current date, date the cached value 110, 112 was generated, length of time between a current time and a time the cached value 110, 112 was generated or stored, etc.); input and output data (e.g., cached machine-learned output 110, input 104, 106 used to generate the cached machine-learned output 110, machine-learned embeddings of inputs 104, 106 or outputs 110, etc.); keyword data (e.g., data indicative of whether an input 104, 106 or cached value 110, 112 includes one or more predetermined time-related or time-sensitive keywords such as “today,” “recently,” “October,” etc.); category data (e.g., current events, history, science, etc.); or other appropriate input data.

In some instances, an age of a cached value 110, 112 (i.e., an amount of time that has passed since the cached value 110, 112 was first generated or since the cached value 110, 112 was most recently edited, evaluated, approved, etc.) can be compared to one or more age thresholds, and can be determined to be fresh if the age is less than an applicable threshold, or not fresh if the age is greater than the applicable threshold. Example thresholds can include default or catch-all thresholds (e.g., maximum 1-year or 1-month age for all cached machine-learned outputs 110, etc.); category-specific thresholds (e.g., one-day threshold for outputs categorized as current events; one-hour threshold for outputs categorized as breaking news; one-year or longer threshold for outputs categorized as history; etc.); keyword-specific thresholds (e.g., one-day threshold for inputs 104, 106 or cached machine-learned outputs 110 comprising the word “today,” etc.); or other appropriate thresholds.

In some instances, a cache output 114 can include an “empty” output indicative of a lack of cached machine-learned output 110 or other cached value 112 associated with a corresponding initial input 104 or retrieval input 106. An “empty” output can include, for example, an error message; a null value; a zero value or other placeholder value; a cache output 114 that is not fresh according to a freshness threshold; or any other data or signal indicative of a lack of suitable cached value 110, 112 corresponding to an input 104, 106. Further example details of an example system for handling “empty” cache outputs are described below with respect to FIG. 4.

Outputs 116 can be, comprise, be comprised by, or otherwise share one or more properties with cache outputs 114 or cached machine-learned outputs 110. In some instances, a computing system 102 can directly output a cache output 114 or cached machine-learned outputs 110 as an output 116. In other instances, the computing system 102 can generate, retrieve, or otherwise determine an output 116 based on a cache output 114. In some instances, generating an output 116 based on a cache output 114 can be performed using a machine-learned model. For example, in some instances, generating an output 116 based on a cache output 114 can be performed using a second machine-learned generative model that is different from a machine-learned generative model used to generate one or more cached machine-learned outputs 110. In some instances, the second machine-learned generative model can include a lightweight model having a reduced complexity (e.g., reduced parameter count, reduced computational cost, reduced memory footprint, reduced latency during inference tasks, quantized model having reduced parameter bitwidth, etc.) compared to the machine-learned generative model used to generate the cached machine-learned outputs 110. In some instances, a second machine-learned generative model can include a client-side model configured to be executed by a client device (e.g., smartphone, laptop, tablet, etc.) having limited computational resources (e.g., memory, matrix multiplication capabilities, etc.). For example, in some instances, a second machine-learned generative model can include a reduced-memory-footprint model (e.g., quantized model, distilled reduced-parameter-count model, etc.) generated based on the machine-learned generative model used to generate the cached machine-learned outputs 110. In some instances, generating an output 116 based on a cache output 114 can be performed without using a machine-learned model (e.g., according to a deterministic algorithm; according to one or more predefined instructions such as API instructions; etc.). In some instances, an output 116 can include a cached machine-learned output 110 and additional output data, such as explanatory information, output data generated by a machine-learned model, or other output data. As a non-limiting illustrative example, a cache output 114 may include a cached machine-learned output 110 retrieved based on a retrieval input 106 that may be different from an initial input 104. In such instances, a computing system 102 may output an output 116 comprising the cache output 114 and an explanation that the cache output 114 was generated based on an input that is slightly different from the initial input 104. As a non-limiting illustrative example, a computing system 102 can, responsive to receiving an initial input 104 of “wahts the weather today” from a client computing device located in Cleveland, output an output 116 comprising one or more explanatory sentences such as “Showing answers generated for the question: ‘What is today's forecast in Cleveland, Ohio?’ Click HERE to generate a new answer for the question: ‘wahts the weather today.’” Additional example details of example systems for generating an output 116 that may be different from a cache output 114 are further provided below with respect to FIGS. 4 and 6.

FIG. 2 is a block diagram of an example system for determining or suggesting retrieval inputs 106 based on a similarity between an initial input 104 and a suggested or determined retrieval input 106. A computing system 102 can receive an initial input 104. Based on the initial input 104, a similarity system 202 of the computing system 102 can determine one or more similarity-based retrieval inputs/suggestions 206.

A similarity system 202 can be, comprise, be comprised by, or otherwise share one or more properties with a computing system 102. For example, the similarity system 202 can be a component (e.g., software component, etc.) of the computing system 102. The similarity system 202 can be or include one or more software, firmware, or hardware components configured to process initial inputs 104 to generate similarity-based retrieval input(s)/suggestion(s) 206. Because the similarity system 202 can be a component of a computing system 102, any activity attributable to the similarity system 202 can be attributed to the computing system 102.

Similarity-based retrieval inputs/suggestions 206 can be, comprise, by comprised by, or otherwise share one or more properties with retrieval input(s) 106. For example, in some instances, similarity-based retrieval inputs/suggestions 206 can be used directly as retrieval inputs 106 (e.g., without further processing, approval, or other further action). In some instances, a similarity-based retrieval input/suggestion 206 can include a suggested value that is suggested for use as a retrieval input 106. In some instances, a suggested value can be provided to a user or computing system for approval (e.g., user approval, automated approval, etc.). Upon receiving approval for a suggested value, the suggested value can be used as a retrieval input 106.

Determining a similarity-based retrieval input/suggestion 206 can include, for example, generating the similarity-based retrieval input/suggestion 206 based on an initial input 104; retrieving the similarity-based retrieval input/suggestion 206 (e.g., from a cache datastore 108) based on an initial input 104; or other method for determining a similarity-based retrieval input/suggestion 206.

Retrieving a similarity-based retrieval input/suggestion 206 based on an initial input 104 can include, for example, retrieving based on a metric of similarity between the initial input 104 and one or more retrieval inputs 106 stored in the cache datastore 108 (e.g., stored as part of an input-output pair or similar data item of the cache datastore 108). Similarity metrics can include, for example, machine-learning-based similarity metrics; edit-distance-based similarity metrics; keyword-based similarity metrics; or other similarity metrics. A similarity metric based on machine learning can include, for example, a metric of similarity between a first machine-learned embedding associated with an initial input 104 and a second machine-learned embedding associated with a similarity-based retrieval input/suggestion 206. A metric of similarity between machine-learned embeddings can include, for example, a metric of vector distance (e.g., cosine distance, Euclidean distance, Manhattan distance, etc.) between two vector-based machine-learned embeddings. A similarity metric based on edit distance can include, for example, a minimum number of items (e.g., characters, words, tokens, substrings, etc.) that would need to be added, deleted, or replaced to convert an initial input 104 into a corresponding similarity-based retrieval input/suggestion 206. As a non-limiting illustrative example, a Levenshtein edit distance can be a minimum number of characters that would need to be added, deleted, or replaced to convert an initial input 104 into a corresponding similarity-based retrieval input/suggestion 206. A keyword-based similarity metric can include, for example, one or more metrics based on keyword frequency (e.g., term frequency-inverse document frequency (TF-IDF), best matching 25 (BM25), etc.). For example, a keyword-based similarity metric can be determined based at least in part on a number or percentage of items (e.g., words, tokens, phrases, etc.) that belong to both an initial input 104 and a similarity-based retrieval input/suggestion 206, and based at least in part on a frequency or likelihood of each shared item in a corpus of inputs 104, 106, 206 (e.g., frequency of each item within cached inputs of the cache datastore 108, etc.).

In some instances, retrieving based on a metric of similarity can include comparing a metric of similarity to a similarity threshold. For example, if a metric of “distance” (e.g., edit distance, semantic embedding distance, etc.) between an initial input 104 and a candidate similarity-based retrieval input/suggestion 206 is less than or equal to the similarity threshold, then the candidate similarity-based retrieval input/suggestion 206 can be accepted as a valid suggested value or retrieval input 106. As another example, if a metric of “distance” between an initial input 104 and a candidate similarity-based retrieval input/suggestion 206 greater than a distance threshold, then the candidate similarity-based retrieval input/suggestion 206 can be rejected and discarded. In some instances, if none of a plurality of candidate similarity-based retrieval inputs/suggestions 206 (e.g., plurality of inputs of a cache datastore 108 comprising input-output pairs, etc.) satisfy a similarity threshold, an “empty” cache output 114 can be returned. In some instances, if more than one of a plurality of candidate similarity-based retrieval inputs/suggestions 206 (e.g., plurality of inputs of a cache datastore 108 comprising input-output pairs, etc.) satisfy a similarity threshold, then a “most similar” candidate similarity-based retrieval input/suggestion 206 can be selected as a retrieval input 106 or similarity-based retrieval suggestion 206.

In some instances, a plurality of similarity thresholds can be employed. For example, a first similarity threshold can be used to determine whether a candidate similarity-based retrieval input/suggestion 206 is sufficiently similar to be used as a suggestion, and a second similarity threshold can be used to determine whether a candidate similarity-based retrieval input/suggestion 206 is sufficiently similar to be used directly as a retrieval input 106 (e.g., without suggestion and approval). In some instances, a similarity threshold can include an exact-match threshold requiring an initial input 104 to be exactly equal to all or part of a similarity-based retrieval input/suggestion 206. As a non-limiting illustrative example, a computing system 102 can use a candidate similarity-based retrieval input/suggestion 206 as a retrieval input 106 without any additional user interaction if the retrieval input 106 is an exact match for the initial input 104. Continuing the non-limiting illustrative example, the computing system 102 can, responsive to determining that a candidate similarity-based retrieval input/suggestion 206 satisfies a second similarity threshold but is not an exact match for an initial input 104, use the candidate similarity-based retrieval input/suggestion 206 as a retrieval input 106 without prior user approval and provide the user with a notification highlighting the differences between the retrieval input 106 and initial input 104. Continuing the non-limiting illustrative example, the computing system 102 can, responsive to determining that a candidate similarity-based retrieval input/suggestion 206 satisfies a third similarity threshold but does not satisfy the second similarity threshold, provide the candidate similarity-based retrieval input/suggestion 206 as a suggestion for approval by a user. Upon approval by the user, the computing system 102 can use the approved similarity-based retrieval input/suggestion 206 as a retrieval input 106.

In some instances, determining a similarity-based retrieval input/suggestion 206 can include autocompletion. For example, a computing system 102 can receive an initial input 104 comprising a partial input context to a generative machine-learned model (e.g., partial sentence, partial phrase, partial paragraph, or other partial input context). Based on the the partial input context, the computing system 102 can determine (e.g., generate, retrieve, etc.) one or more possible completed input contexts. In some instances, a similarity-based retrieval input/suggestion 206 can be, comprise, or be comprised by a completed input context generated in this manner. In some instances, a completed input context can include an input that begins with all or part of the initial input 104, and includes one or more additional tokens after the end of the included portion of the initial input 104. As a non-limiting illustrative example, an initial input 104 can be “What is Jane Johnson's husband's,” and each of a plurality of completed input contexts can include the initial input 104 followed by one or more additional tokens, such as “name?”, “height?”, “favorite restaurant?”, “sister's occupation?”, etc. In some instances, a completed input context may not include any of the initial input 104. For example, in some instances, a completed input context may include a paraphrasing or rephrasing of the initial input 104. As a non-limiting illustrative example, responsive to receiving an initial input 104 of “Tell me about the wea”, a computing system 102 may generate autocompletions such as “Tell me about the weather?”, “What is the weather today?”, etc., which may or may not include all or part of the initial input 104.

In some instances, determining one or more completed input contexts can include retrieving the completed input contexts (e.g., from a data structure correlating partial inputs to completed inputs). For example, in some instances, generating similarity-based retrieval inputs/suggestions 206 based on autocompletion can include word-by-word, token-by-token, character-by-character, sentence-by-sentence, or other repeated retrieval of completed input contexts. For example, each time a computing system 102 receives an additional word or token (e.g., from a user, etc.) of an initial input 104, the computing system 102 can perform an autocompletion retrieval based on the initial input 104 received so far. In some instances, a data structure for correlating partial input contexts to corresponding autocompletions can include a tree data structure, wherein each word added to the initial input 104 corresponds to a branch of the tree data structure. In some instances, the tree data structure can include or be accompanied by a tree-structured data index to facilitate efficient retrieval of autocompletions from the tree data structure. As a non-limiting illustrative example, a computing system 102 can receive an initial input 104 consisting of the word “What”; and retrieve, based on the initial input 104, a plurality of autocompletion suggestions associated with the word “What” (e.g., “What is the weather like today?” “What movies are coming out this weekend?”, etc.). In some instances, the computing system 102 can further retrieve index data correlating potential second words of the initial input 104 (i.e., potential two-word input contexts starting with “What”) with data entries (e.g., data entries comprising autocompletion suggestions; data entries comprising index data; etc.) associated with the second words. Continuing the non-limiting illustrative example, the index data may include an entry correlating “is” to data (e.g., memory locations, storage locations, database identification numbers, database index values, etc.) indicative of one or more data entries (e.g., autocompletion data entries, index data entries, etc.) associated with an initial input 104 of “What is.” Upon receiving “is” as a second word of the initial input 104, the computing system 102 can retrieve autocompletion data for completing a partial input context beginning with “What is.” This process can be repeated for third words, fourth words, nth words, etc.

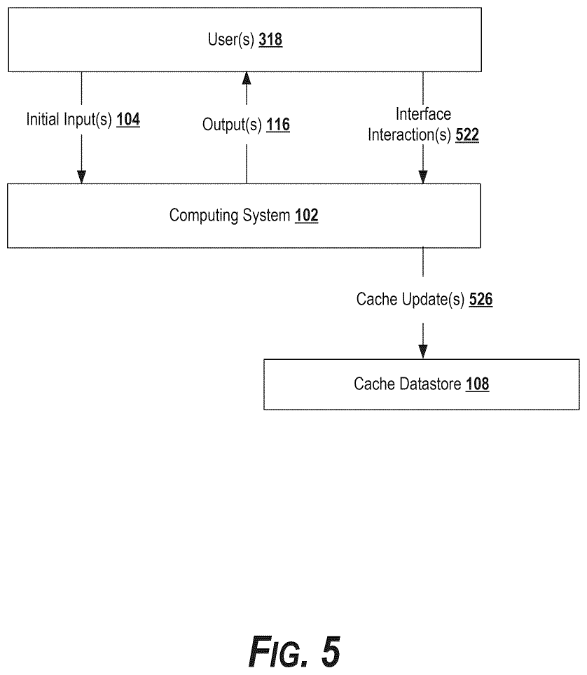

In some instances, a similarity-based retrieval input/suggestion 206 can be determined based at least in part on one or more of: usage patterns (e.g., usage patterns associated with a cache datastore 108, initial input 104, similarity-based retrieval input/suggestion 206, or other system or data value); quality metrics (e.g., metrics of user satisfaction or user acceptance rates, metrics indicative of compliance with prompt engineering best practices, etc.); metrics of suggestion diversity (e.g., similarity to or difference from suggestions already included in a plurality of autocompletion suggestions); or other relevant data. For example, in some instances, a plurality of autocompletion suggestions associated with a partial input (e.g., “What”, etc.) can include the top n most popular inputs 104, 106 selected by users after typing in an exact match for the partial input. Additional details of some example implementations for updating a similarity system 202 or cache datastore 108 based on user interactions are further provided below with respect to FIG. 5.

In some instances, autocompletions can be retrieved based on an exact match of a partial input context, or can be retrieved based on an inexact match. For example, in some instances, autocompletions can be determined according to any similarity-based retrieval described herein (e.g., similarity based on machine-learned embeddings, edit distance, keyword frequency, etc.). In some instances, autocompletions can be determined based on a similarity between the autocompletion and the initial input 104, or based on a similarity between an initial input 104 and a second partial input associated with the autocompletion. As a non-limiting illustrative example, an autocompletion of “What is” may include “What is the weather today?” and may be stored in a data structure as a data pair correlating “What is” with “What is the weather today?” In such instances, an autocompletion system can compare an initial input 104 (e.g., “Tell me about the”) to the partial input “What is”; to the completed input “What is the weather today?”; or to another appropriate comparison value.

In some instances, determining a similarity-based retrieval input/suggestion 206 can include autocorrection. For example, upon detection of an unexpected token in an initial input 104 (e.g., out-of-vocabulary token such as “waht”; token that is inappropriate or otherwise unexpected for a particular context, such as “Which tastes better, bison jerky or dear jerky?”; etc.), a computing system 102 can determine one or more candidate similarity-based retrieval inputs/suggestions 206, wherein the unexpected token can be removed, altered, or replaced. In some instances, an alternate token for replacing the unexpected token can be determined based on one or more of: a similarity between the unexpected token and the alternate token; an overall frequency of the alternate token in a corpus of inputs (e.g., inputs in input-output pairs of a cache datastore 108); an expected in-context frequency of the alternate token (e.g., according to a machine-learned next-token prediction output, etc.); or other relevant data. For example, an autocorrection score can be generated based on a combination (e.g., sum, product, or other mathematical combination) of a metric of similarity (e.g., between an unexpected token and an alternate token; between an initial input 104 and a candidate similarity-based retrieval input/suggestion 206; etc.) and a metric of likelihood (e.g., overall frequency, machine-learned frequency expectation, etc.). In some instances, the autocorrection score can be compared to one or more autocorrection score thresholds, and a candidate similarity-based retrieval input/suggestion 206 can be accepted, rejected, or suggested to a user based on the comparison(s). In some instances, determining a similarity-based retrieval input/suggestion 206 based on autocorrection can include identifying an unexpected or erroneous token in an initial input 104; retrieving, from a data structure correlating unexpected or erroneous tokens to corrected tokens, a corrected token; and replacing the unexpected or erroneous token with the retrieved corrected token. In some instances, an autocorrection-based similarity-based retrieval input/suggestion 206 can be used directly as a retrieval input 106 (e.g., with or without user approval or notification) or provided to the user as a suggested value for use as a retrieval input 106 upon approval by the user.

In some instances, determining (e.g., generating) a similarity-based retrieval input/suggestion 206 can include mapping an initial input 104 to a reduced input space. An input space can include, for example, an alphabet; a vocabulary (e.g., token vocabulary, natural language vocabulary, etc.); a grammar (e.g., syntax, etc.); a context window length or other input length dimension; or other input space dimension. In some instances, a size of an input space can be reduced by reducing a size of an alphabet (e.g., converting to all lower case, deleting all punctuation, etc.); reducing a size of a vocabulary (e.g., by mapping a plurality of synonyms to a single synonym of the plurality of synonyms; by removing words having a low information content, such as “of,” “the,” “a,” etc.); reducing a token length of the input (e.g., by representing common phrases as single tokens); mapping a grammar of the initial input 104 to a simplified grammar; or otherwise mapping an initial input 104 to a reduced input space. In some instances, mapping an initial input 104 to a reduced input space can include machine-learned dimensionality reduction (e.g., principal component analysis, generalized discriminant analysis, etc.). In some instances, mapping an initial input 104 to a reduced input space can include mapping a natural language initial input 104 to a domain-specific input language.

In some instances, determining (e.g., generating) a similarity-based retrieval input/suggestion 206 can include mapping an initial input 104 to a domain-specific input language. A domain-specific input language can include, for example, a language having a structured grammar or syntax; a reduced token vocabulary compared to a natural language; a reduced alphabet compared to a natural language; or other feature for reducing a dimensionality of the domain-specific input language compared to a dimensionality of an initial input 104 (e.g., dimensionality of a natural language associated with the initial input 104). In some instances, a domain-specific input language can be human-defined (e.g., according to linguistic analysis, etc.), machine-learned (e.g., according to a machine-learned dimensionality reduction model), or a combination thereof (e.g., human-in-the-loop verification of machine-learned outputs, etc.).

In some instances, a similarity-based retrieval input/suggestion 206 can include additional context associated with an initial input 104. For example, in some instances, an initial input 104 can be a single turn of a multi-turn conversation, and a similarity-based retrieval input/suggestion 206 can be determined based at least in part on context from other turns of the multi-turn conversation. As a non-limiting illustrative example, a multi-turn conversation may begin with a user saying, “I am planning a trip to Cleveland this weekend,” and a later turn of the conversation may be an initial input 104 saying “What will the weather be like?” In such instances, a similarity-based retrieval input/suggestion 206 can include, for example, “What will the weather be like in Cleveland this weekend?” In some instances, determining a similarity-based retrieval input/suggestion 206 comprising additional context from an earlier turn of a multi-turn conversation can include various forms of similarity-based retrieval (e.g., machine-learning-based, keyword-based, etc.) as described above. For example, in some instances, a machine-learned sequence processing model can determine a contextualized machine-learned embedding of an initial input 104, wherein the contextualized machine-learned embedding is determined based at least in part on one or more earlier turns of the multi-turn conversation (e.g., according to an attention mechanism, etc.). In such instances, the contextualized machine-learned embedding of the initial input 104 can be compared to a context-free embedding of a candidate similarity-based retrieval input/suggestion 206, and a best similarity-based retrieval input/suggestion 206 can be determined based on a metric of similarity (e.g., cosine distance, Euclidean distance, etc.) between the machine-learned embeddings. In this manner, for instance, a contextualized machine-learned embedding of “What will the weather be like?” in the context of a “trip to Cleveland this weekend” can be compared to a context-free embedding of “What will the weather be like in Cleveland this weekend?”, and a similarity-based retrieval input/suggestion 206 of can be selected based at least in part on the comparison. Additionally, in some instances, a similarity-based retrieval input/suggestion 206 can be generated (e.g., instead of being retrieved as described above) based on a contextualized embedding. For example, in some instances, a contextualized embedding can be generated by an encoder portion of an encoder-decoder machine-learned model based on an initial input 104 and other context; and a contextualized similarity-based retrieval input/suggestion 206 can be generated by decoding the contextualized embedding using a decoder portion of an encoder-decoder machine-learned model (e.g., transformer, etc.).

In some instances, additional context associated with an initial input 104 can include context retrieved from sources other than a multi-turn conversation. For example, in some instances, additional context can include knowledge stored by a digital personal assistant according to a user's commands or preferences. As a non-limiting illustrative example, a user may instruct a digital personal assistant (e.g., voice-activated mobile assistant application, etc.) to store or otherwise access location data associated with a user or device (e.g., static location data associated with a user's hometown, office address, favorite restaurant address, etc.; dynamic location data such as current location of a device according to GPS data, etc.) to facilitate improved navigation services, recommendation services, and the like. In such instances, additional context associated with an initial input 104 can include location data, such as a city associated with a device's current location. In some instances, determining a similarity-based retrieval input/suggestion 206 based on such additional context can include determining, by a computing system 102, that an initial input 104 includes a context-dependent input; retrieving, by the computing system 102 based on the determining, context data on which the context-dependent input may depend; and determining, based at least in part on the initial input 104 and the context data, a similarity-based retrieval input/suggestion 206. In some instances, determining the similarity-based retrieval input/suggestion 206 based on the initial input 104 and the context data can include generating a contextualized embedding of the initial input 104 based on the context data, and comparing the contextualized embedding to a context-free embedding of a candidate similarity-based retrieval input/suggestion 206 (e.g., for similarity-based retrieval as described above). In some instances, context data can be added to initial input 104 according to other methods, such as machine-learned addition or deterministic grammar-based addition of natural language context. As a non-limiting illustrative example, a computing system 102 may determine that an initial input 104 is a context-dependent initial input 104 (e.g., “What is the weather today?”, etc.) that depends on one or more identified context items (e.g., location, date, etc.); retrieve context data corresponding to the identified context items; and add the context items to the initial input 104 (e.g., by appending “in Cleveland” according to deterministic grammar rules, etc.). As another example, a machine-learned encoder-decoder model can generate a contextualized encoding of the initial input 104 based on the context data; then decode the contextualized encoding to generate a similarity-based retrieval input/suggestion 206 that includes the context data.

FIG. 3 is a block diagram of an example system for determining retrieval inputs 106 based on a user interaction. A computing system 102 can receive one or more initial inputs 104 from a user 318. Based on the initial inputs 104, the computing system 102 can provide one or more input suggestions 320 to the user 318. The computing system 102 can receive, from the user 318, one or more interface interactions 322 indicative of user acceptance of at least one of the one or more input suggestions 320. Based on the interface interaction(s) 322, the computing system 102 can determine one or more interaction-based retrieval inputs 306.

An interaction-based retrieval input 306 can be, comprise, be comprised by, or otherwise share one or more properties with a retrieval input 106. For example, an interaction-based retrieval input 306 can have any property described above with respect to a retrieval input 106. In some instances, an interaction-based retrieval input 306 can comprise an input suggestion 320 that was accepted by a user according to an interface interaction 322 (e.g., by clicking an “Accept” button or the like; by pressing a key such as Tab or Enter to accept an autocompletion or autocorrection suggestion; by not clicking on a button, link, or other input component for rejecting an input suggestion 320; etc.).

A user 318 can include, for example, any user interacting directly or indirectly with the systems described herein (e.g., computing system 102, etc.). For example, a user can include a person interacting with the computing system 102 directly (e.g., using input/output hardware devices, etc.); interacting with the computing system 102 via a client device connected to the computing system 102 over a network; etc. In some instances, a user 318 can include or be associated with a user account (e.g., account associated with an individual or organizational user) or user device (e.g., client computing device, etc.).

An input suggestion 320 can be, comprise, be comprised by, or otherwise share one or more properties with a similarity-based retrieval input/suggestion 206. For example, an input suggestion 320 can have any property described above with respect to a similarity-based retrieval input/suggestion 206, and can be determined (e.g., generated, retrieved, etc.) in any manner described above with respect to a similarity-based retrieval input/suggestion 206. In some instances, an input suggestion 320 can have one or more properties of a retrieval input 106 or interaction-based retrieval input 306. For example, upon acceptance by a user according to an interface interaction 322, an input suggestion 320 can be used as an interaction-based retrieval input 306, and a cache output 114 can be retrieved based on the interaction-based retrieval input 306.

An interface interaction 322 can include any interaction between a device and a user 318, including an interaction characterized by user inactivity. For example, an interface interaction 322 can include providing, by the computing system 102, one or more outputs (e.g., communications, messages, text outputs, audio outputs, natural language outputs, etc.) to the user 318. For example, an output to the user 318 can include an input suggestion 320 and one or more other output values (e.g., message explaining the input suggestion 320 and asking the user to accept or reject the input suggestion 320, etc.). In some instances, an interface interaction 322 can include causing, by the computing system 102, an input component (e.g., graphical user interface component such as button, link, etc.) to be provided to the user 318 to solicit user feedback regarding the input suggestion 320. In some instances, the computing system 102 can provide such an input component to the user 318 directly (e.g., by providing a signal to an input/output device of the computing system 102), or indirectly (e.g., by providing a signal to another device, such as a client computing device associated with the user 318). In some instances, an interface interaction 322 can include receiving, by the computing system 102, one or more inputs from the user 318. Example inputs can include mouse inputs (e.g., left-click, right-click, double-click; mouseover or other cursor movement; etc.); keyboard inputs (e.g., tab, enter, or other keystroke to accept an autocompletion suggestion; text-based input to an interactive chatbot, such as “Yes” or “No” responsive to an output message comprising an input suggestion 320; keyboard inputs for deleting, editing, or adding text data to an input suggestion 320; etc.); touchscreen inputs (e.g., mouse-like touchscreen inputs for “clicking” on an onscreen object; touchscreen keyboard inputs; etc.); voice inputs (e.g., via a microphone input device); still image or video inputs (e.g., via a camera input device); or other input type. In some instances, an input from a user 318 can be directly indicative of a user acceptance (e.g., clicking a thumbs up or Accept button, entering a keystroke to accept an autocomplete suggestion, etc.) or rejection (e.g., thumbs down, Reject button, etc.) of an input suggestion 320. In some instances, an input from a user 318 or other interface interaction 322 can be indirectly indicative of a user acceptance or rejection of an input suggestion 320 (e.g., follow-up question typed into an interactive chatbot, etc.).

In some instances, an interface interaction 322 may not include receiving, by the computing system 102, any inputs from the user 318. For example, in some instances, an interface interaction 322 can include a message indicating that a lack of user input will be treated as an acceptance of the input suggestions 320 (e.g., “Showing results for [autocorrected input suggestion 320]. Click to see results for [uncorrected initial input 104].”). In such instances, an interface interaction 322 may include determining, by the computing system 102, that a user has not provided (e.g., after a predetermined period of time, etc.) an input indicating dissatisfaction with an input suggestion 320; and retrieving, from the cache datastore 108 responsive to the determining, a cache output 114 based on the input suggestion 320.

Responsive to an interface interaction 322 indicative of a user 318 acceptance of an input suggestion 320, the computing system 102 can use the input suggestion 320 as an interaction-based retrieval input 306. The computing system 102 can then perform, based at least in part on the interaction-based retrieval input 306, other activities (e.g., retrieval from a cache datastore 108 based on the interaction-based retrieval input 306, etc.) described herein with respect to other Figures.

FIG. 4 is a block diagram of an example system for generating new machine-learned outputs when a suitable cached output is not available. A computing system 102 can receive an initial input 104. Based on the initial input 104, the computing system can determine a retrieval input 106 to retrieve a cached output from the cache datastore 108. Responsive to retrieving an empty output 414 indicating that a suitable cached value 110, 112 for responding to the initial input 104 is not available, the computing system 102 can provide an input context 404 based on the initial input 104 to a machine-learned generative model. Based on the input context 404, the machine-learned generative model 424 can generate a generated output 416. Based on the generated output 416, the computing system 102 can output an output 116. In some instances, the generated output 416 can be subsequently stored in the cache datastore 108.

An empty output 414 can be or include, for example, any data indicative of a lack of cached value 110, 112 suitable for responding to an initial input 104. An empty output 414 can include, for example, an error message; a null value; a zero value or other placeholder value; or any other data or signal indicative of a lack of cached value 110, 112 corresponding to an input 104, 106. Although the empty output 414 is depicted in FIG. 4 as being retrieved or received based on a retrieval input 106, an empty output 414 can also include any data indicative of a lack of suitable retrieval input 106 for retrieving a cached value 110, 112 corresponding to an initial input 104. For example, in instances where a retrieval input 106 is determined by retrieving the retrieval input 106 from a cache datastore 108 comprising input-output pairs (e.g., pairs of retrieval inputs 106 and corresponding cached values 110, 112), an empty output 414 can include any data (e.g., error message, null value, similarity metric that does not exceed a similarity threshold, etc.) indicating that a suitable retrieval input 106 is not present in the cache datastore 108.

A generated output 416 can include any machine-learned output generated by a machine-learned generative model 424. In some instances, a generated output 416 can include an output sequence (e.g., text sequence, image sequence, audio sequence, video sequence, multimodal sequence, etc.). In some instances, a generated output 416 can be, comprise, be comprised by, or otherwise share one or more properties with an output 116. For example, a generated output 416 can have any property described herein with respect to an output 116. In some instances, a generated output 416 can be used directly by a computing system 102 as the output 116 (e.g., without modification), or the computing system 102 can determine an output 116 based at least in part on the generated output 416.

In some instances, a generated output 416 can be stored in the cache datastore 108. In some instances, the generated output 416 can be stored in combination with other data, such as the initial input 104 or input context 404 used to generate the generated output 416; freshness data associated with the generated output 416 (e.g., expiration date, etc.); or other relevant data. In some instances, freshness data can include data described above with respect to FIG. 1. In some instances, freshness data can include an expiration date determined by the computing system 102 (e.g., immediately before or after the generated output 416 is generated). In some instances, a computing system 102 can determine an expiration date using a lightweight machine-learned model (e.g., having a smaller number of parameters than a generative machine-learned model for generating cached machine-learned outputs 110, etc.), such as a lightweight neural network model (e.g., multilayer perceptron, etc.). In some instances, an input to a machine-learned expiration date model can include date and time data (e.g., current date and time, etc.); input and output data (e.g., generated output 416, input 104, 404 used to generate the generated output 416, machine-learned embeddings of inputs 104, 404 or outputs 416, etc.); keyword data (e.g., data indicative of whether an input 104, 404 or generated output 416 includes one or more predetermined time-related or time-sensitive keywords such as “today,” “recently,” “October,” etc.); category data (e.g., current events, history, science, etc.); or other appropriate input data. In some instances, an expiration date can be determined based on one or more predetermined output age thresholds. As a non-limiting illustrative example, if a generated output 416 is subject to a one-month maximum age threshold, then an expiration date can be determined by adding one month to the date and time on which the generated output 416 was generated. Example thresholds can include default or catch-all thresholds (e.g., maximum 1-year or 1-month age for all generated outputs 416, etc.); category-specific thresholds (e.g., one-day threshold for outputs categorized as current events; one-hour threshold for outputs categorized as breaking news; one-year or longer threshold for outputs categorized as history; etc.); keyword-specific thresholds (e.g., one-day threshold for inputs 104, 404 or generated outputs 416 comprising the word “today,” etc.); or other appropriate thresholds.

Although FIG. 4 depicts generating and storing a generated output 416 responsive to receiving an initial input 104, a generated output 416 can in some instances be generated and stored responsive to other events. For example, in some instances, a cache can be prefilled based at least in part on a usage pattern associated with a machine-learned generative model 424, input context 404, cache datastore 108, or other system or data. In some instances, a cache can be prefilled based at least in part on freshness data associated with one or more data entries of the cache datastore 108. For example, in some instances, an expired data entry of the cache datastore 108 can be replaced immediately upon expiration (e.g., by providing an input of the expired data entry to the machine-learned generative model 424 as input context 404, etc.), without waiting to receive an initial input 104 associated with the data entry. In some instances, a future input value (e.g., initial input 104 value, etc.) can be anticipated based on past input values received by the computing system 102 (e.g., from one or more users 318); the future input value can be provided as input context 404 to a machine-learned generative model 424 to generate a generated output 416; and the generated output can be stored in the cache datastore 108 (e.g., before a corresponding initial input 104 is actually received by the computing system 102). In this manner, for instance, a latency of providing a generated output 416 (e.g., to a user) can be reduced.

In some instances, data entries of the cache datastore 108 can be precomputed during a time characterized by off-peak usage of one or more systems (e.g., computing system comprising a machine-learned generative model 424, electrical system supplying a machine-learned generative model 424, etc.). This can include, for example, predetermined scheduling of computations during predicted periods of off-peak usage; dynamically adjusting load based on measures of current usage; or other methods. For example, in some instances, a computing system 102 can track usage data of one or more hardware devices (e.g., computing devices; processors such as graphics processing units, tensor processing units, application-specific integrated circuits, etc.). Based on the usage data, the computing system 102 can identify one or more first time periods (e.g., times of day; days or hours of a week or month; etc.) associated with peak or near-peak usage of the hardware devices and one or more second time periods associated with off-peak usage. For example, in some instances, the computing system 102 can predict future usage based on past usage data (e.g., using machine-learned time series prediction; statistical methods such as seasonal autoregressive integrated moving average, etc.; or other method) and identify a future time window in which usage of the hardware devices is expected to be above a threshold; below a threshold; or the like. In some instances, a computing system 102 can store one or more planned future updates of the cache datastore 108 (e.g., using a data structure correlating a plurality of retrieval inputs 106 to a plurality of times before which a corresponding update of the cache datastore 108 is planned, etc.). Based on a comparison between the planned future updates and predicted usage data, the computing system 102 can select an optimal time to generate one or more new outputs for the cache datastore 108. In this manner, for instance, a number of hardware devices needed to meet a computational demand associated with a machine-learned generative model 424 can be reduced (e.g., by reducing a maximum number of hardware devices being used simultaneously, etc.).

Similarly, a computing system 102 can track past power usage or power cost data; predict future usage or cost data based on the past data; and select, based on a comparison between predicted power data and a plurality of future inferences to be performed, an optimal time to perform each future inference. In this manner, for instance, a cost of powering one or more machine-learned inferences can be reduced. In some instances, a computing system 102 can also predict future power generation data, such as future solar power or wind power generation data (e.g., based on a weather forecast or other input data), and select an optimal time based in part on the predicted power generation data. For example, a computing system 102 may prioritize scheduling one or more future inferences for updating the cache datastore 108 during a time period when a surplus of renewable energy is available, thereby reducing an environmental cost of generating outputs 416 using a machine-learned model 424.

In some instances, precomputing during periods of off-peak usage can include tracking a current usage (e.g., usage of one or more hardware devices, total power usage, non-renewable power usage, power cost, etc.) and dynamically scheduling one or more inferences when usage is temporarily low. For example, a cloud computing system comprising a machine-learned model 424 may be configured to scale up a number of active (e.g., powered up; on standby waiting to perform inference using a machine-learned model 424 in response to an input 104, 106; etc.) devices (e.g., computing devices, processors, etc.) during time periods (e.g., hours of the day, etc.) when average usage across the time period is expected to be high, and scale down when average usage is expected to be low. In such instances, actual usage may temporarily fluctuate above or below a predicted average usage. In such instances, a computing system 102 can maintain a data structure of planned future updates to the cache datastore 108 (e.g., prioritized queue with most urgent cache updates at the front of the queue, etc.), and can perform an update whenever current usage of the active devices drops below a threshold (e.g., threshold percentage of the active devices, etc.). Similarly, a computing system 102 can track power usage data (e.g., usage data associated with a plurality of computing devices, usage data associated with a power grid as a whole, etc.) and can dynamically schedule one or more inferences when power usage drops below a threshold (e.g., whenever the computing system 102 detects a surplus of renewable energy that can be used to perform machine-learned inference, etc.). In this manner, for instance, various costs (e.g., hardware costs, electricity costs, etc.) of machine-learned output generation can be reduced.

The machine-learned generative model 424 can include one or more machine-learned models. The machine-learned generative model 424 can include various model architectures, such as various neural network model architectures. An example model architecture for a machine-learned generative model 424 can include a sequence processing model architecture (e.g., a transformer model). For example, the machine-learned generative model 424 can be configured to receive an input sequence and generate an output sequence. For instance, the machine-learned generative model 424 can be configured to generate an output sequence where elements of the output sequence are predicted based on the elements of the input sequence. In some instances, a machine-learned generative model 424 can include a generative language model (e.g., natural language model such as text-based, audio-based, or multimodal natural language model). In some instances, a machine-learned generative model 424 can include a model for generating a non-language-based output (e.g., image output, video output, etc.) based on a natural language input (e.g., text, audio, etc.). In some instances, a machine-learned generative model 424 can include a model architecture having an attention mechanism (e.g., self-attention). In some instances, the machine-learned generative model 424 can be a pre-trained model (e.g., pretrained using large-scale unsupervised learning). In some instances, the machine-learned generative model 424 can be fine-tuned over one or more fine-tuning datasets, such as a fine-tuning dataset associated with one or more specialized generation tasks.

FIG. 5 is a block diagram of an example system for updating a cache datastore 108 based on user interface interactions. A computing system 102 can receive one or more initial inputs 104 from one or more users 318. Based on the initial inputs 104, the computing system 102 can provide one or more outputs 116 to the user(s) 318 (e.g., in a manner described above with respect to FIGS. 1-4). The computing system 102 can receive, from the user(s) 318, one or more interface interactions 522 indicative of a user satisfaction, dissatisfaction, or other opinion associated with the output(s) 116. Based on the interface interaction(s) 522, the computing system 102 can provide one or more cache updates 526 to the cache datastore 108.

An interface interaction 522 can be, comprise, be comprised by, or otherwise share one or more properties with an interface interaction 322. For example, an interface interaction 522 can have any property described above with respect to an interface interaction 322. In some instances, an interface interaction 522 can include an output to a user 318 comprising an output 116 (e.g., along with a message or interface component soliciting feedback regarding the output 116, etc.). An interface interaction 522 can include an input or lack of input from a user 318 as described above with respect to an interface interaction 322 (e.g., thumbs up or other clicking interaction, keyboard interaction, etc.). In some instances, an interface interaction 522 can include a natural language input (e.g., provided via a chatbot interface, mobile digital assistant interface, etc.) directly or indirectly indicative of user satisfaction or dissatisfaction with an output 116 (e.g., “Thanks!”, “thats hilarious haha”, “That's not quite what I was looking for,” follow-up question rephrasing an initial input 104, etc.).

A cache update 526 can include, for example, any update to a cache datastore 108, or any update to a system for determining retrieval inputs 106 for retrieving cached values 110, 112 from the cache datastore 108. In some instances, a cache update 526 can include adding an output 116 to the cache datastore 108 (e.g., as a cached machine-learned output 110) responsive to one or more interface interactions 522 indicative of user satisfaction with the output 116. In some instances, a cache update 526 can include adding a template based on or otherwise associated with an output 116 to the cache datastore (e.g., as an other cached value 112) responsive to one or more interface interactions 522 indicative of user satisfaction with the final output 116. In some instances, a cache update 526 can include removing a cached value 110, 112 responsive to one or more interface interactions 522 indicative of user dissatisfaction with an output 116. In some instances, a cache update 526 can include modifying or replacing a cached value 110, 112 based on one or more interface interactions 522.

In some instances, a cache update 526 can include an update to a system for determining retrieval inputs 106 for retrieving data from the cache datastore 108. For example, in some instances, a cache update 526 can include adding, removing, modifying, or replacing one or more data entries correlating an initial input 104 to a retrieval input 106 used to retrieve a cache output 114 used to determine an output 116 (e.g., responsive to more interface interactions 522 indicative of user satisfaction or dissatisfaction with the output 116). In some instances, a cache update 526 can include adding, removing, modifying, or replacing one or more data entries correlating a retrieval input 106 to a cached value 110, 112 used to generate an output 116 (e.g., responsive to more interface interactions 522 indicative of user satisfaction or dissatisfaction with the final output 116). In some instances, a cache update 526 can include other updates to a system for determining (e.g., retrieving, generating, etc.) retrieval inputs 106 based on initial inputs 104, such as increasing or decreasing a similarity threshold; modifying one or more parameters associated with a parameterized similarity metric (e.g., machine-learned similarity determination, etc.); or other update.

FIG. 6 is a block diagram of an example system for determining outputs 116 based on cached output templates. A computing system 102 can receive an initial input 104. Based on the initial input 104, the computing system can determine a retrieval input 106. Based on the retrieval input 106, the computing system can retrieve one or more cached templates 614. Based on the cached template(s) 614, the computing system 102 can provide one or more template-based inputs 628 to a template completion system 630, which can generate a completed output 616 based on the template-based input(s) 628. Based on the completed output(s) 616, the computing system 102 can generate an output 116.

A cached template 614 can be, comprise, be comprised by, or otherwise share one or more properties with a cache output 114 or other cached value 112. For example, a cached template 614 can be stored and retrieved in a manner similar to (e.g., same as) a manner described above with respect to cached machine-learned outputs 110 and other cached values 112.

In some instances, a cached template 614 can include, for example, any or all of: instruction content for generating all or part of an output; stored content comprising one or more partial outputs (e.g., precomputed or cached partial outputs); instruction content for combining two or more partial outputs; and the like.

In some instances, instruction content for generating all or part of an output can include instructions associated with an application programming interface (API). For example, in some instances, a cached template 614 can include an API instruction configured to be provided to an API as-is. In some instances, a cached template 614 can include instruction content for generating an API instruction to be provided to an API. For example, in some instances, a cached template 614 can include input context configured to cause a machine-learned model (e.g., machine-learned generative model 424, etc.) to generate an API instruction based on the input context. In some instances, a computing system 102 can provide the input context to a machine-learned model; receive, from the machine-learned model, an output comprising an API instruction; provide, to an API, the API instruction; receive, from the API, an API output; and determine a completed output 616 based at least in part on the API output.

In some instances, a cached template 614 can include one or more partial output values (e.g., templates, sentences, paragraphs, etc.) to be included in an output 116 or otherwise used to generate a completed output 616. For example, in some instances, a cached template 614 component for generating all or part of an output can include a fill-in-the-blank template configured to cause a template completion system 630 to generate a partial output (e.g., using an API, using a machine-learned model, etc.) to be combined with the fill-in-the-blank template to generate a completed output 616.

In some instances, instruction content for generating all or part of an output can include instruction content configured to be provided to a machine-learned model (e.g., machine-learned generative model 424, etc.). For example, in some instances, instruction content for generating all or part of an output can include one or more of: a system prompt describing a machine-learned model's role, goals, and other system properties; an instruction to generate an output having one or more properties specified by the instruction; one or more output examples for the machine-learned model to emulate (e.g., example input-output pairs, few-shot or many-shot prompts, chain-of-thought prompts, etc.); or other input context. In some instances, a cached template 614 can include one or more intermediate computational values (e.g., machine-learned embeddings, etc.) for computing all or part of an output (e.g., machine-learned partial output, etc.). For example, in some instances, a machine-learned generative model 424 can include a plurality of layers, wherein each layer between an input layer and an output layer of the machine-learned generative model 424 can be called a hidden layer. In some instances, an output of a hidden layer can be called a machine-learned embedding or machine-learned encoding. In some instances, one or more machine-learned embeddings for generating all or part of an output can be precomputed and stored in the cache datastore in a cached template 614. As a non-limiting illustrative example, a machine-learned generative model 424 may include a query-key-value attention mechanism, wherein computing an output comprises determining one or more machine-learned embeddings (e.g., “key” embeddings) based on one or more tokens (e.g., words, etc.) of an input context, and then generating an output based at least in part on the machine-learned embeddings. Continuing the non-limiting illustrative example, key embeddings can be precomputed based on an input context for generating a partial output (e.g., input sequence in a non-embedded format, such as raw text, audio, image, video, natural language sequence such as a fill-in-the-blank template, etc.), and stored as part of a cached template 614. In this manner, for instance, a computational cost of generating a plurality of completed outputs 616 for a plurality of users 318 based on a cached template 614 can be reduced.

In some instances, a cached template 614 can include instruction content for combining two or more partial outputs. Instruction content for combining two or more partial outputs can include, for example, deterministic computer code in a programming language (e.g., String.concat(“The answer to your question is:”, myAPI.getAnswer( )); etc.), instruction content configured to be provided to a machine-learned generative model 424 (e.g., natural language instructions such as “Please review the API output provided below, and fill in the blanks in the following sentence: The high temperature today in Cleveland will be ______”, etc.); or other instruction content for combining two or more partial outputs.

As a non-limiting illustrative example, an input saying “Tell me about today's weather” may be associated with a cached template 614 for retrieving and outputting weather data. For example, continuing the non-limiting illustrative example, a weather application may have a weather API for retrieving the most recent weather data, and a cached template 614 can include an instruction for calling the weather API to retrieve today's high temperature; low temperature; current temperature; precipitation likelihood; or other weather data. The cached template 614 can further include, for example, one or more instructions for incorporating the retrieved API output into a completed output 616. For example, the cached template 614 can include a “fill-in-the-blank” template component, such as “Today's high temperature is <API-high-temp> and today's low temperature is <API-low-temp>, with a <API-precip-chance> of precipitation. The current temperature is <API-current-temp>.”

A completed output 616 can include any output generated by a template completion system 630 based on a cached template 614. In some instances, a completed output 616 can be, comprise, be comprised by, or otherwise share one or more properties with an output 116 or generated output 416. For example, in some instances, a completed output 616 can be provided by a computing system 102 as an output 116 (e.g., without modification).

Template-based inputs 628 can be, comprise, be comprised by, share one or more properties with, or be determined (e.g., generated, etc.) based on, cached templates 614. For example, in some instances, a computing system 102 can provide a cached template 614 directly to a template completion system 630. In some instances, a computing system 102 can process a cached template 614 to determine one or more template-based inputs 628 based on the cached template 614. For example, a template completion system 630 may in some instances include a plurality of components, such as one or more API components; one or more machine-learned model components; or other components. In some instances, a computing system 102 can determine, based on a cached template 614, a plurality of template-based inputs 628 to provide to a plurality of components of the template completion system 630. In some instances, one or more outputs of a first component of the template completion system 630 (e.g., partial output configured to be provided as an output 116, etc.) can be provided to a second component of the template completion system 630 (e.g., a component for combining two or more partial outputs, etc.) as a template-based input 628.

A template completion system 630 can be, comprise, be comprised by, or otherwise share one or more properties with a computing system 102. For example, the completion system 630 can include one or more components (e.g., software components, etc.) of the computing system 102. The template completion system 630 can be or include one or more software, firmware, or hardware components configured to process template-based inputs 628 to generate completed outputs 616. In some instances, the template completion system 630 can include one or more API tools configured to generate all or part of a completed output 616 based on an API instruction. In some instances, the template completion system 630 can include one or more machine-learned models (e.g., machine-learned generative model 424, etc.) to generate all or part of a completed output 616 based on a template-based input 628. For example, in some instances, a template completion system 630 can include a second machine-learned generative model that is different from the machine-learned generative model 424. In some instances, the second machine-learned generative model can include a lightweight model having a reduced complexity (e.g., reduced parameter count, reduced computational cost, reduced memory footprint, reduced latency during inference tasks, quantized model having reduced parameter bitwidth, etc.) compared to the machine-learned generative model 424. In some instances, a second machine-learned generative model can include a client-side model configured to be executed by a client device (e.g., smartphone, laptop, tablet, etc.) having limited computational resources (e.g., memory, matrix multiplication capabilities, etc.). For example, in some instances, a second machine-learned generative model can include a reduced-memory-footprint model (e.g., quantized model, distilled reduced-parameter-count model, etc.) generated based on the machine-learned generative model 424. Because the template completion system 630 can be a component of a computing system 102, any activity attributable to the template completion system 630 can be attributed to the computing system 102.

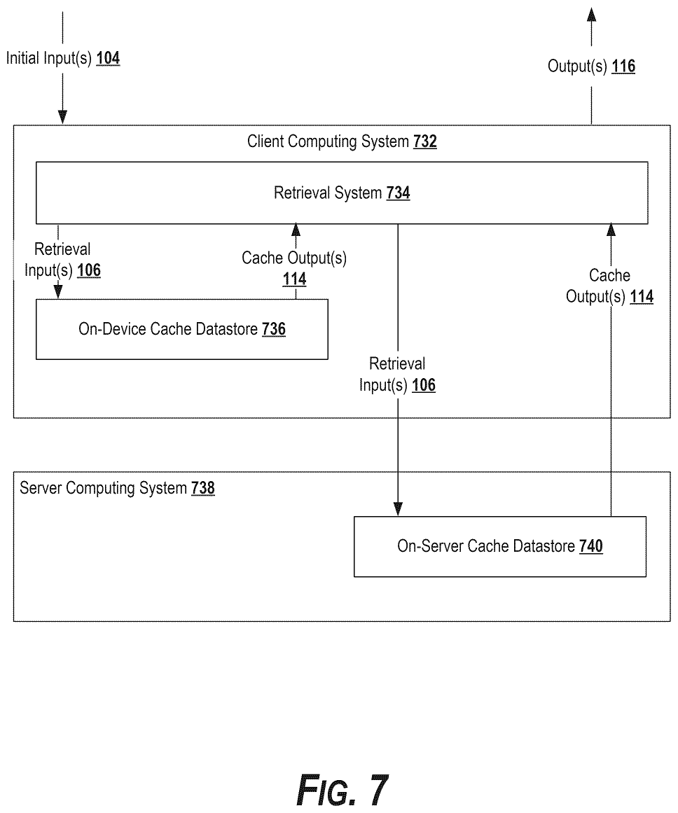

FIG. 7 is a block diagram of an example system for storing all or part of a cache datastore 108 on a client computing system or a server computing system. A client computing system 732 can receive an initial input 104. Based on the initial input 104, a retrieval system 734 of the client computing system 732 can generate one or more retrieval input(s) 106 to retrieve one or more cached output(s) 114. In some instances, a cached output 114 can be retrieved from an on-device cache datastore 736 stored on the client computing system 732. In some instances, a cached output 114 can be retrieved from an on-server cache datastore 740 associated with a server computing system 738.

A client computing system 732 can be, comprise, be comprised by, or otherwise share one or more properties with a computing system 102. A client computing system 732 can include, for example, a client device (e.g., mobile device such as smartphone or tablet; personal computing device such as laptop or desktop computing device; etc.) associated with a user 318.

A retrieval system 734 can be, comprise, be comprised by, or otherwise share one or more properties with a client computing system 732. For example, the retrieval system 734 can be a component (e.g., software component, etc.) of the client computing system 732. The retrieval system 734 can be or include one or more software, firmware, or hardware components configured to process initial inputs 104 to retrieve cache outputs 114 from an on-device cache datastore 736 or on-server cache datastore 740. Because the retrieval system 734 can be a component of a client computing system 732, any activity attributable to the retrieval system 734 can be attributed to the client computing system 732.

An on-device cache datastore 736 can be, comprise, be comprised by, or otherwise share one or more properties with a cache datastore 108. For example, in some instances, an on-device cache datastore 736 can include a portion of a larger cache datastore 108 (e.g., on-server cache datastore 740, etc.). For example, in some instances, an on-device cache datastore 736 can include a reduced-size partial cache datastore 108 configured to fit within a storage space or memory (e.g., non-volatile memory, volatile or semi-volatile memory, etc.) of the client computing system 732, and an on-server cache datastore 740 can include a larger-sized or more complete cache datastore 108 configured to fit within a larger storage space associated with one or more server-side storage devices.

In some instances, a computing system 102 can populate an on-device cache datastore 736 based at least in part on prior usage data associated with a cache datastore 108, machine-learned generative model 424, or other system depicted herein. For example, in some instances, a computing system 102 can receive, from a user 318, one or more first initial inputs 104; determine, based on the first initial inputs 104, a usage pattern associated with the user 318; and prefill, based on the determining, the on-device cache datastore 736 (e.g., by adding new data items that are not yet stored in the on-device cache datastore 736). Prefilling the on-device cache datastore 736 can include adding prompts that are similar to (e.g., according to a metric of similarity or similarity threshold as described above with respect to FIG. 2) prior initial inputs 104; share one or more categories or properties with prior initial inputs 104; or are otherwise associated with prior initial inputs 104 provided by or to a client computing system 732 (e.g., by a user 318).

In some instances, a computing system 102 can further populate an on-device cache datastore 736 with custom context data that may be specific to a client computing system 732 or user 318. For example, in some instances, a user 318 may instruct a client computing system 732 or component thereof (e.g., mobile digital assistant of a client computing system 732) to store certain data with the permission of the user 318. For example, a user 318 may instruct a client computing system to remember location data; contact data associated with the user 318′s contacts; appointment data or calendar data; prior generated outputs 416 generated for a user 318; cached templates 614 based on prior interactions with the user 318; other user-specific data such as flight data or hotel data associated with an upcoming trip, ticket data associated with an upcoming event, etc.

A server computing system 738 can be, comprise, be comprised by, or otherwise share one or more properties with a computing system 102. A server computing system 738 can include, for example, a server device associated with a computing services provider (e.g., software as a service provider, cloud computing provider, machine learning services provider, etc.). In some instances, the server computing system 738 can be operatively connected to the client computing system 732 (e.g., via a network). Further details of an example implementation of a server computing system operatively connected to a client computing system via a network are provided below with respect to FIG. 18.

An on-server cache datastore 740 can be, comprise, be comprised by, or otherwise share one or more properties with a cache datastore 108. The on-server cache datastore 740 can include data stored in non-volatile, volatile, or semi-volatile memory or storage space. The on-server cache datastore 740 can include data stored on one device or across multiple devices (e.g., multiple computing devices, multiple storage devices, etc.).

In some instances, retrieving cache outputs 114 based on retrieval inputs 106 can include a two-level retrieval process. For example, a retrieval system 734 can receive an initial input 104; determine, based on the initial input 104, one or more retrieval inputs 106 for retrieving from an on-device cache datastore 736; and attempt to retrieve a cache output 114 from the on-device cache datastore 736. Responsive to retrieving an empty output 414 (e.g., from the on-device cache datastore 736; from a system for determining retrieval inputs 106 for retrieving from the on-device cache datastore 736; etc.), the retrieval system 734 can retrieve cache output(s) 114 from the on-server cache datastore 740. In some instances, the retrieval system 734 can generate one or more second retrieval inputs 106 for retrieving from the on-server cache datastore 740, which may be different from the one or more retrieval inputs 106 for retrieving from the on-device cache datastore 736. In some instances, the retrieval system 734 can reuse the same retrieval inputs 106 for retrieving from both the on-device cache datastore 736 and the on-server cache datastore 740.

### Example Methods

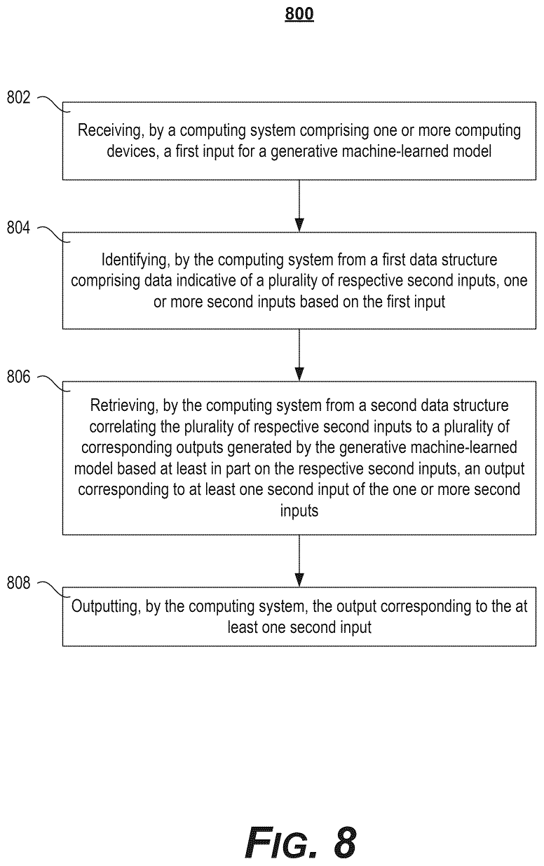

FIG. 8 depicts a flowchart diagram of an example method for retrieving a cached machine-learned output according to example embodiments of the present disclosure. Although FIG. 8 depicts steps performed in a particular order for purposes of illustration and discussion, the methods of the present disclosure are not limited to the particularly illustrated order or arrangement. The various steps of example method 800 can be omitted, rearranged, combined, and/or adapted in various ways without deviating from the scope of the present disclosure.

At 802, example method 800 can include receiving, by a computing system (e.g., computing system 102) comprising one or more computing devices, a first input (e.g., initial input 104) for a machine-learned sequence processing model (e.g., machine-learned generative model 424). In some instances, example method 800 at 802 can include using one or more systems or performing one or more activities described with respect to FIGS. 1-3.

At 804, example method 800 can include identifying, by the computing system from a first data structure (e.g., cache datastore 108, similarity system 202) comprising data indicative of a plurality of respective second inputs (e.g., retrieval inputs 106), one or more second inputs based on the first input. Identifying a second input can include, for example, retrieving the second input; retrieving other data indicative of a second input (e.g., embedding data, hash data, index data, input identification number, etc.); identifying (e.g., determining, generating, retrieving, etc.) data for retrieving an output corresponding to the second input (e.g., generated by a generative machine-learned model based on the second input) from a data structure correlating inputs to outputs; or the like. In some instances, example method 800 at 804 can include using one or more systems or performing one or more activities described with respect to FIGS. 1-3.

At 806, example method 800 can include retrieving, by the computing system from a second data structure (e.g., cache datastore 108) correlating the plurality of respective second inputs to a plurality of corresponding outputs (e.g., cached machine-generated outputs 110, other cached values 112, cache outputs 114, etc.) generated by the generative machine-learned model based at least in part on the respective second inputs, an output (e.g., cache output 114, output 116, etc.) corresponding to at least one second input of the one or more second inputs. Data correlating the second inputs to the corresponding outputs can include, for example, a plurality of data items each correlating data indicative of or associated with a second input (e.g., embedding value, hash value, index value, identification number, second input itself, etc.) with data indicative of or associated with a corresponding output. As used herein, an item (e.g., system, method, component, data item, etc.) designated by an ordinal number (e.g., first, second, third, fourth, etc.) can be the same item or a different item compared to a similarly named item designated by a different ordinal number. For example, in example method 800, a first data structure can be the same data structure as a second data structure, or can be a different data structure from the second data structure. The same is true for other ordinal numbers (e.g., third, fourth, etc.) and other item types (e.g., input, output, etc.) throughout this application. In some instances, example method 800 at 806 can include using one or more systems or performing one or more activities described with respect to FIG. 1.

At 808, example method 800 can include outputting, by the computing system, the output corresponding to the at least one second input. In some instances, example method 800 at 808 can include using one or more systems or performing one or more activities described with respect to FIG. 1.

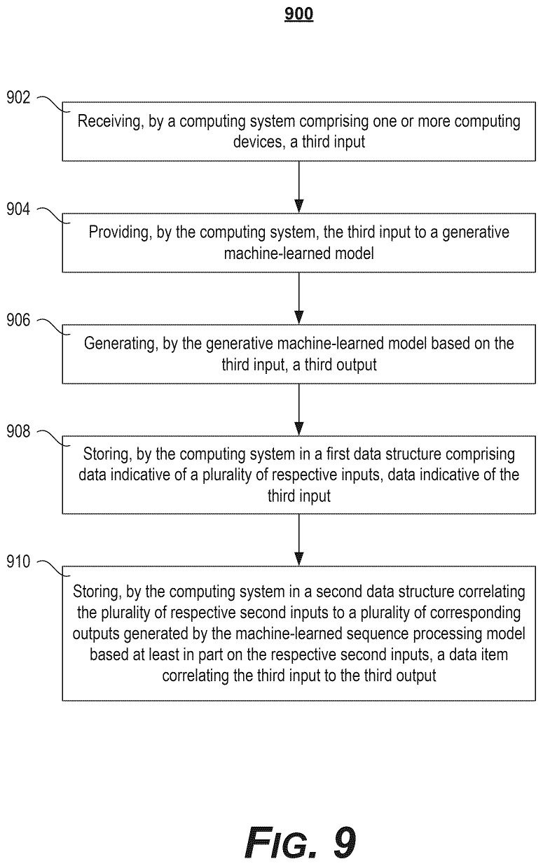

FIG. 9 depicts a flowchart diagram of an example method for generating and storing machine-learned outputs according to example embodiments of the present disclosure. Although FIG. 9 depicts steps performed in a particular order for purposes of illustration and discussion, the methods of the present disclosure are not limited to the particularly illustrated order or arrangement. The various steps of example method 900 can be omitted, rearranged, combined, and/or adapted in various ways without deviating from the scope of the present disclosure.

At 902, example method 900 can include receiving, by a computing system (e.g., computing system 102) comprising one or more computing devices, a third input (e.g., initial input 104). In some instances, example method 900 at 902 can include using one or more systems or performing one or more activities described with respect to FIG. 4.

At 904, example method 900 can include providing, by the computing system, the third input to a generative machine-learned model (e.g., machine-learned generative model 424). In some instances, example method 900 at 904 can include using one or more systems or performing one or more activities described with respect to FIG. 4.

At 906, example method 900 can include generating, by the generative machine-learned model based on the third input, a third output (e.g., generated output 416). In some instances, example method 900 at 906 can include using one or more systems or performing one or more activities described with respect to FIG. 4.

At 908, example method 900 can include storing, by the computing system in a first data structure (e.g., cache datastore 108, similarity system 202, etc.) comprising data indicative of a plurality of respective second inputs, data indicative of the third input. In some instances, example method 900 at 908 can include using one or more systems or performing one or more activities described with respect to FIG. 4.

At 910, example method 900 can include storing, by the computing system in a second data structure (e.g., cache datastore 108) correlating the plurality of respective second inputs to a plurality of corresponding outputs generated by the machine-learned sequence processing model based at least in part on the respective second inputs, a data item correlating the third input to the third output. In some instances, example method 900 at 910 can include using one or more systems or performing one or more activities described with respect to FIG. 4.

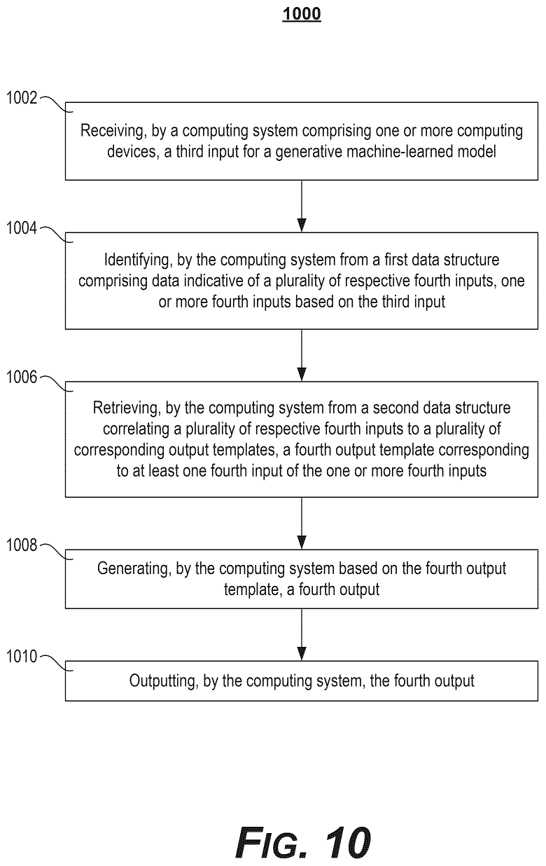

FIG. 10 depicts a flowchart diagram of an example method for generating an output based on a cached template according to example embodiments of the present disclosure. Although FIG. 10 depicts steps performed in a particular order for purposes of illustration and discussion, the methods of the present disclosure are not limited to the particularly illustrated order or arrangement. The various steps of example method 1000 can be omitted, rearranged, combined, and/or adapted in various ways without deviating from the scope of the present disclosure.

At 1002, example method 1000 can include receiving, by a computing system (e.g., computing system 102) comprising one or more computing devices, a third input (e.g., initial input 104) for a generative machine-learned model. In some instances, example method 1000 at 1002 can include using one or more systems or performing one or more activities described with respect to FIG. 6.

At 1004, example method 1000 can include identifying, by the computing system from a first data structure (e.g., cache datastore 108, similarity system 202) comprising data indicative of a plurality of respective fourth inputs, one or more fourth inputs (e.g., retrieval inputs 106) based on the third input. In some instances, example method 1000 at 1004 can include using one or more systems or performing one or more activities described with respect to FIG. 6.

At 1006, example method 1000 can include retrieving, by the computing system from a second data structure (e.g., cache datastore 108) correlating a plurality of respective fourth inputs to a plurality of corresponding output templates, a fourth output template (e.g., cached template 614) corresponding to at least one fourth input of the one or more fourth inputs. In some instances, example method 1000 at 1006 can include using one or more systems or performing one or more activities described with respect to FIG. 6.

At 1008, example method 1000 can include generating, by the computing system based on the fourth output template, a fourth output (e.g., completed output 616, output 116, etc.). In some instances, example method 1000 at 1008 can include using one or more systems or performing one or more activities described with respect to FIG. 6.

At 1010, example method 1000 can include outputting, by the computing system, the fourth output. In some instances, example method 1000 at 1010 can include using one or more systems or performing one or more activities described with respect to FIG. 6.

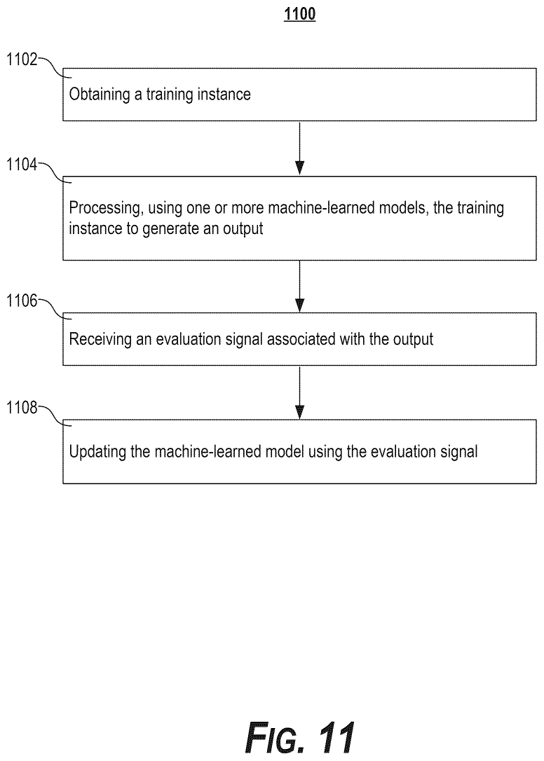

FIG. 11 depicts a flowchart of a method 1100 for training one or more machine-learned models according to aspects of the present disclosure. For instance, an example machine-learned model can include a machine-learned generative model 424.

One or more portion(s) of example method 1100 can be implemented by a computing system that includes one or more computing devices such as, for example, computing systems described with reference to the other figures. Each respective portion of example method 1100 can be performed by any (or any combination) of one or more computing devices. Moreover, one or more portion(s) of example method 1100 can be implemented on the hardware components of the device(s) described herein, for example, to train one or more systems or models. FIG. 11 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 11 is described with reference to elements/terms described with respect to other systems and figures for exemplary illustrated purposes and is not meant to be limiting. One or more portions of example method 1100 can be performed additionally, or alternatively, by other systems.

At 1102, example method 1100 can include obtaining a training instance. A set of training data can include a plurality of training instances divided between multiple datasets (e.g., a training dataset, a validation dataset, or testing dataset). A training instance can be labeled or unlabeled. Although referred to in example method 1100 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 1104, example method 1100 can include processing, using one or more machine-learned models, the training instance to generate an output. The output can be directly obtained from the one or more machine-learned models or can be a downstream result of a chain of processing operations that includes an output of the one or more machine-learned models.

At 1106, example method 1100 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi-or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 1108, example method 1100 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 1100 can include implementing a number of generalization techniques (e.g., weight decays, dropouts, etc.) to improve the generalization capability of the models being trained.

In some implementations, example method 1100 can be implemented for training a machine-learned model from an initialized state to a fully trained state (e.g., when the model exhibits a desired performance profile, such as based on accuracy, precision, recall, etc.).

In some implementations, example method 1100 can be implemented for particular stages of a training procedure. For instance, in some implementations, example method 1100 can be implemented for pre-training a machine-learned model. Pre-training can include, for instance, large-scale training over potentially noisy data to achieve a broad base of performance levels across a variety of tasks/data types. In some implementations, example method 1100 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

### Example Machine-Learned Models

FIG. 12 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV: 2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

### Example Machine-Learned Sequence Processing Models

FIG. 13 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV:2010.11929v2 (Jun. 3, 2021), audio domains, see, e.g., Agostinelli et al., MusicLM: Generating Music From Text, ARXIV:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 13 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

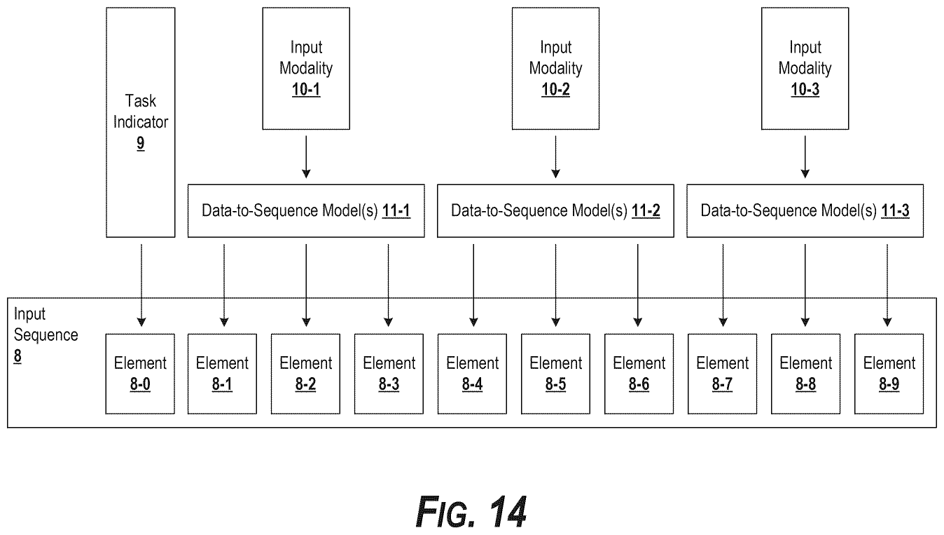

FIG. 14 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

### Example Machine-Learned Model Development Platform

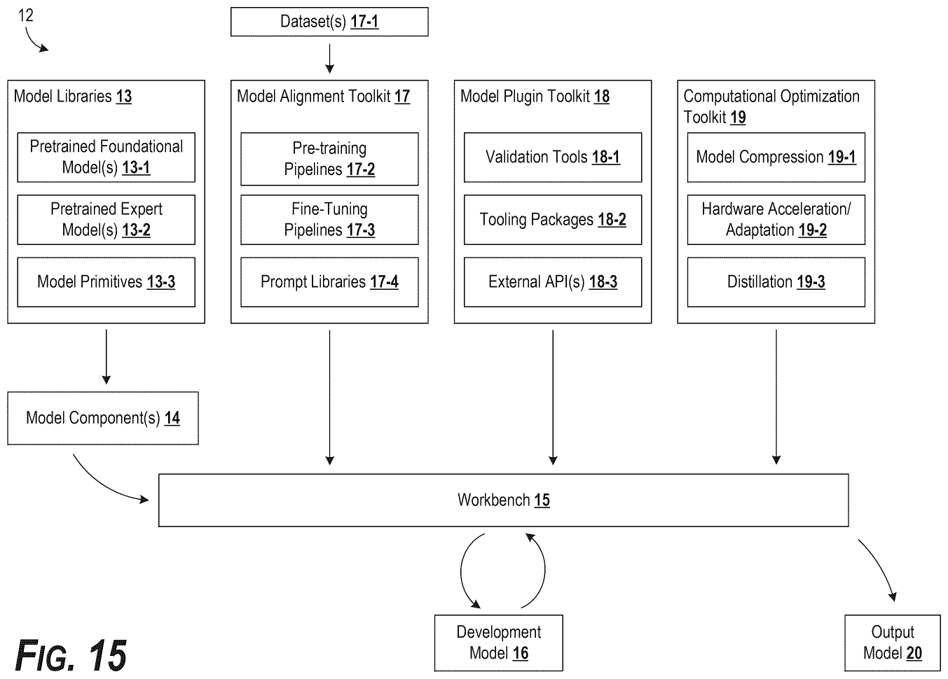

FIG. 15 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output a input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 1100 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

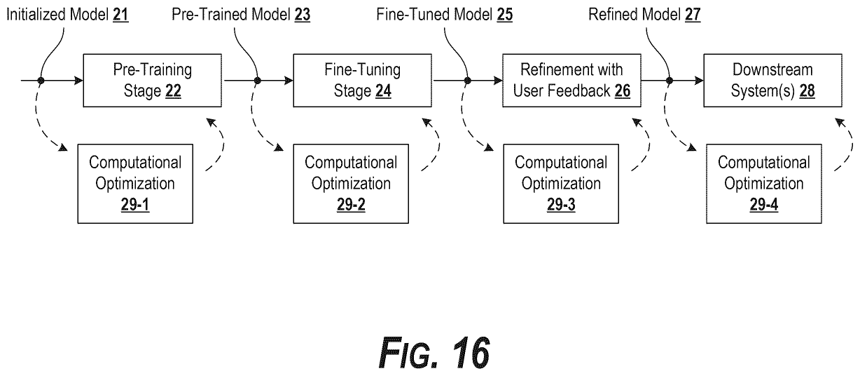

FIG. 16 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 16 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 16 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 25 can then be a new version of development model 16, which can persist as development model 16 or as a new development model. Fine-tuned model 25 can be the initial state if development model 16 was already fine-tuned. Fine-tuned model 25 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

### Example Machine-Learned Model Inference System

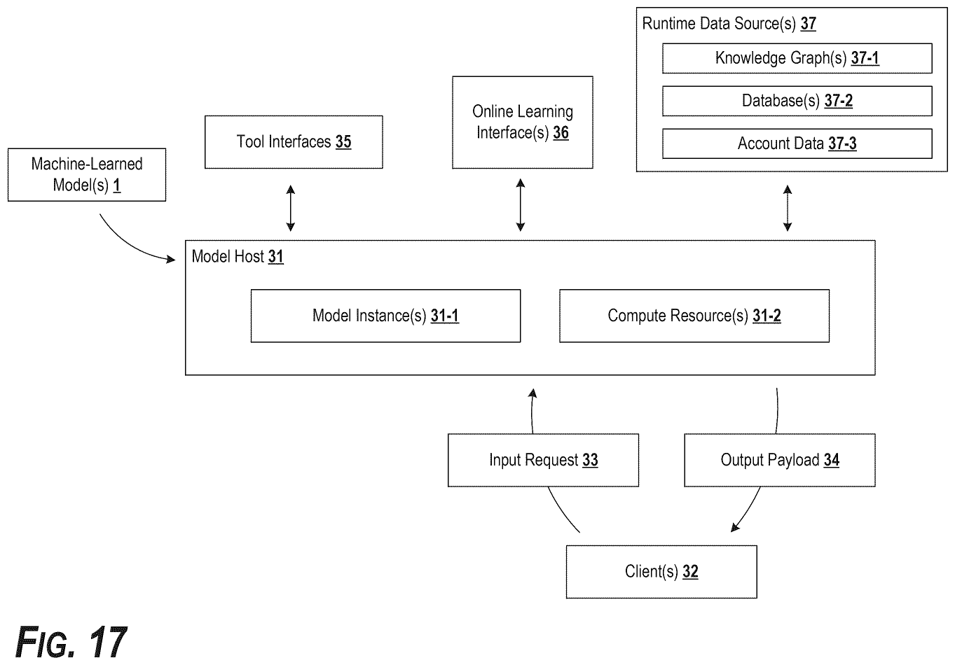

FIG. 17 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at an output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with an output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

### Example Computing Systems and Devices

FIG. 18 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 18 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 18 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

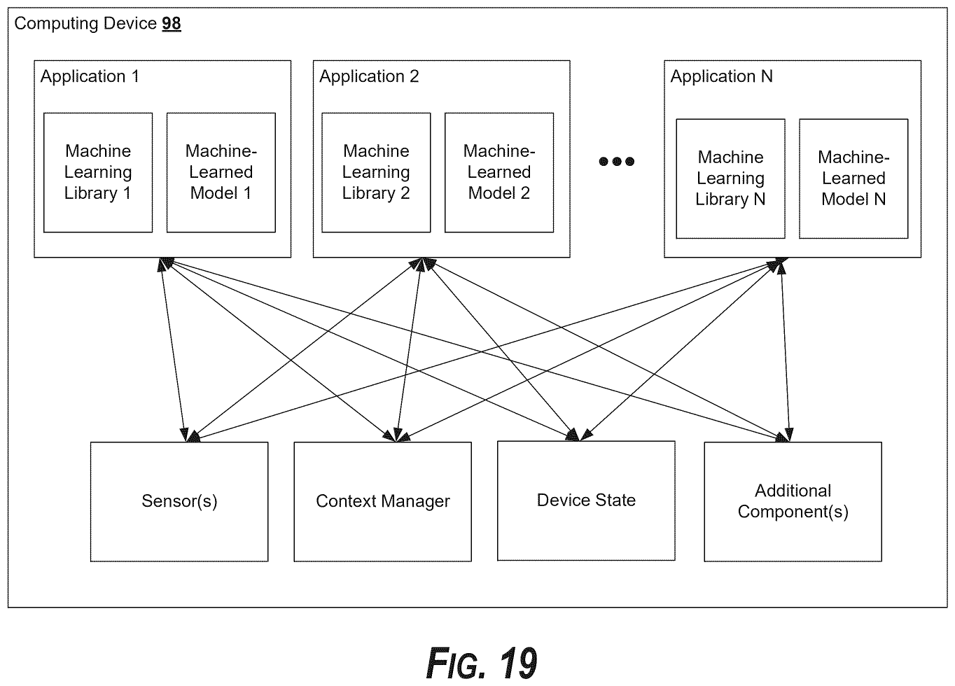

FIG. 19 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 19, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

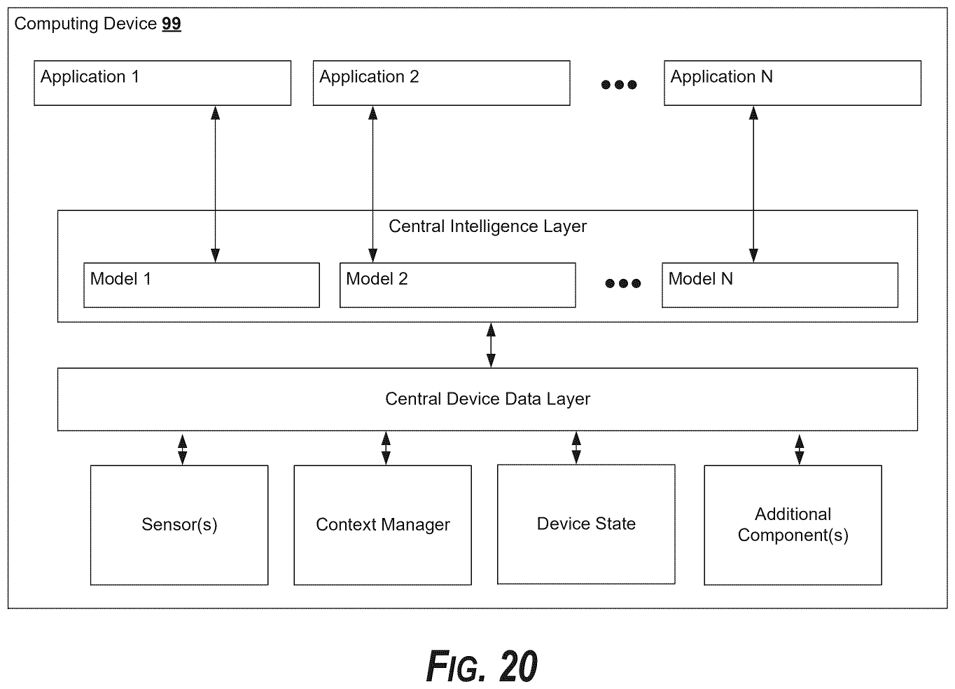

FIG. 20 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 20, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 20, the central device data layer can communicate with a number of other components of the computing device, such as, for example, one or more sensors, a context manager, a device state component, or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method comprising:
receiving, by a computing system comprising one or more computing devices, a first input for a generative machine-learned model;
identifying, by the computing system from a first data structure comprising data indicative of a plurality of respective second inputs, one or more second inputs based on the first input;
retrieving, by the computing system from a second data structure correlating the plurality of respective second inputs to a plurality of corresponding outputs generated by the generative machine-learned model based at least in part on the respective second inputs, an output corresponding to at least one second input of the one or more second inputs; and
outputting, by the computing system, an output value based on the output corresponding to the at least one second input.

2. The computer-implemented method of claim 1, further comprising:
providing, by the computing system to a user prior to retrieving the output corresponding to the at least one second input, the one or more second inputs; and
receiving, by the computing system from the user prior to retrieving the output corresponding to the at least one second input, an interface interaction indicative of the at least one second input;
wherein the output corresponding to the at least one second input is retrieved based on the interface interaction.

3. The computer-implemented method of claim 2, wherein the first data structure comprises a tree data structure, and further comprising:
receiving, by the computing system from the user, one or more first tokens of the first input;
identifying, by the computing system from the first data structure, one or more first input suggestions based at least in part on the one or more first tokens;
receiving, by the computing system from the user subsequent to receiving the first token, one or more second tokens of the first input; and
identifying, by the computing system from the first data structure, the one or more second inputs based at least in part on the one or more first tokens and the one or more second tokens.

4. The computer-implemented method of claim 1, wherein the one or more second inputs are identified based on a metric of similarity between the first input and the one or more second inputs.

5. The computer-implemented method of claim 4, wherein the metric of similarity comprises a metric of distance between a machine-learned embedding of the first input and one or more machine-learned embeddings of the one or more second inputs.

6. The computer-implemented method of claim 4, wherein the metric of similarity comprises a keyword frequency metric.

7. The computer-implemented method of claim 4, wherein the metric of similarity comprises an edit distance metric.

8. The computer-implemented method of claim 4, further comprising:
receiving, by the computing system from a user, an interface interaction associated with the one or more second inputs; and
updating, by the computing system based on the interface interaction, at least one of:
the metric of similarity; and
a similarity threshold, wherein the one or more second inputs are identified based at least in part on the similarity threshold.

9. The computer-implemented method of claim 1, further comprising:
receiving, by the computing system, a third input;
providing, by the computing system, the third input to the generative machine-learned model;
generating, by the generative machine-learned model based on the third input, a third output;
storing, by the computing system in the first data structure, data indicative of the third input; and
storing, by the computing system in the second data structure, a data item correlating the third input to the third output.

10. The computer-implemented method of claim 9, further comprising:
receiving, by the computing system from a user, an interface interaction indicative of user satisfaction with the third output;
wherein storing the data indicative of the third input in the first data structure is based at least in part on the interface interaction; and
wherein storing the data item is based at least in part on the interface interaction.

11. The computer-implemented method of claim 1, further comprising:
receiving, by the computing system from a user, an interface interaction indicative of user dissatisfaction with the output value;
removing, by the computing system from the first data structure or second data structure, at least one of:
a data item used to identify the at least one second input based on the first input; and
a data item correlating the at least one second input to the output corresponding to the at least one second input.

12. The computer-implemented method of claim 1, further comprising:
retrieving, by the computing system from the second data structure, date data indicative of at least one of:
a date the output corresponding to the at least one second input was generated; and
a date after which the output corresponding to the at least one second input is no longer valid;
wherein the outputting is based at least in part on determining, based on the date data, that the output corresponding to the at least one second input is still valid.

13. The computer-implemented method of claim 1, further comprising:
receiving, by the computing system, a third input for the generative machine-learned model;
identifying, by the computing system from the first data structure, one or more fourth inputs based on the third input;
retrieving, by the computing system from a third data structure correlating a plurality of respective fourth inputs to a plurality of corresponding output templates, a fourth output template corresponding to at least one fourth input of the one or more fourth inputs;
generating, by the computing system based on the fourth output template, a fourth output; and
outputting, by the computing system, the fourth output.

14. The computer-implemented method of claim 13, wherein the generative machine-learned model is a first generative machine-learned model, and generating the fourth output comprises:
providing, by the computing system to the generative machine-learned model, data indicative of at least a portion of the fourth output template; and
generating, by the first generative machine-learned model or a second generative machine-learned model based on the data indicative of at least a portion of the fourth output template, at least a portion of the fourth output.

15. The computer-implemented method of claim 14, wherein the generating is performed using the second generative machine-learned model, and the second generative machine-learned model has a number of parameters that is smaller than a number of parameters of the first machine-learned model.

16. The computer-implemented method of claim 13, wherein generating the fourth output comprises:
accessing, by the computing system based at least in part on the fourth output template, an application programming interface; and
receiving, from the application programming interface, at least a portion of the fourth output.

17. The computer-implemented method of claim 1, wherein the first input is associated with a natural language, and identifying the one or more second inputs comprises:
mapping, by the computing system, the first input to a domain-specific input language having at least one of:
a syntax that is different from a syntax of the natural language;
a vocabulary that is different from a vocabulary of the natural language; and
an alphabet that is different from an alphabet of the natural language; and
identifying, by the computing system based at least in part on the mapping, the one or more second inputs.

18. The computer-implemented method of claim 1, further comprising:
providing, by the computing system, a signal to cause a client device to implement an on-device data structure, the on-device data structure comprising at least one of:
the second data structure; and
a data structure correlating a plurality of fifth inputs to a plurality of corresponding fifth outputs generated by the generative machine-learned model based at least in part on the fifth inputs.

19. The computer-implemented method of claim 18, further comprising:
receiving, by the computing system from a user associated with the client device, one or more sixth inputs; and
adding, by the computing system based at least in part on the sixth inputs, one or more data items to the on-device data structure;
wherein at least one data item of the one or more data items comprises data indicative of a seventh input that has not been received by the computing system from the user.

20. The method of claim 1, wherein the generative machine-learned model is a first generative machine-learned model, and further comprising:
determining, by the computing system using a second generative machine-learned model having a number of parameters that is smaller than a number of parameters of the first generative machine-learned model, based on the output corresponding to the at least one second input, the output value.

21. A computing system comprising one or more processors and one or more non-transitory computer-readable media storing instructions that are executable by the one or more processors to cause the computing system to perform operations, the operations comprising:
receiving a first input for a generative machine-learned model;
identifying, from a first data structure comprising data indicative of a plurality of respective second inputs, one or more second inputs based on the first input;
retrieving, from a second data structure correlating the plurality of respective second inputs to a plurality of corresponding outputs generated by the generative machine-learned model based at least in part on the respective second inputs, an output corresponding to at least one second input of the one or more second inputs; and
outputting an output value based on the output corresponding to the at least one second input.

22. One or more non-transitory computer-readable media storing instructions that are executable by a computing system to perform operations, the operations comprising:
receiving a first input for a generative machine-learned model;
identifying, from a first data structure comprising data indicative of a plurality of respective second inputs, one or more second inputs based on the first input;
retrieving, from a second data structure correlating the plurality of respective second inputs to a plurality of corresponding outputs generated by the generative machine-learned model based at least in part on the respective second inputs, an output corresponding to at least one second input of the one or more second inputs; and
outputting an output value based on the output corresponding to the at least one second input.
